(19) United States
(12) Patent Application Publication
(10) Pub. No.: US 2024/0259883 A1
(43) Pub. Date: Aug. 1, 2024

(54) WIRELESS BASE STATION DEVICE, WIRELESS COMMUNICATION SYSTEM, AND WIRELESS COMMUNICATION METHOD

(71) Applicant: NIPPON TELEGRAPH AND TELEPHONE CORPORATION, Tokyo (JP)

(72) Inventors: Akira MATSUSHITA, Musashino-shi, Tokyo (JP); Fumihiro YAMASHITA, Musashino-shi, Tokyo (JP)

(73) Assignee: NIPPON TELEGRAPH AND TELEPHONE CORPORATION, Tokyo (JP)

(21) Appl. No.: 18/566,098

(22) PCT Filed: Jun. 4, 2021
(86) PCT No.: PCT/JP2021/021383

§ 371 Date: Dec. 1, 2023

(51) Int. Cl. H04W 28/26; H04W 28/18; H04W 48/16

(52) U.S. Cl. CPC H04W 28/26; H04W 28/18; H04W 48/16

(57) ABSTRACT

A wireless base station executes first processing, in response to the reception of the radio wave from the wireless terminal, the wireless base station determines the active utilization of the wireless communication service by the wireless terminal on the basis of the past connection record information of the wireless terminal. There is a second processing in a case where the wireless terminal is a terminal that cannot expect active use of the wireless communication service. In the second processing, the wireless base station allocates a communication resource to the wireless terminal under a condition of a predetermined connection operation by the wireless terminal. The third processing is a process in a case where the wireless terminal is a terminal that can expect active use of the wireless communication service. In the third processing, the wireless base station allocates a communication resource to the wireless terminal without a predetermined connection operation.

### TECHNICAL FIELD

The present disclosure relates to a wireless base station device, a wireless communication system in which the wireless base station device and a control device are connected via a communication network, and a wireless communication method.

### BACKGROUND ART

The wireless communication system includes one control device (administration device), a plurality of wireless base station devices (wireless transmission/reception devices), and a communication network. The control device is connected to a plurality of wireless base station devices via a communication network. A plurality of wireless terminals are wirelessly connected to the wireless base station device.

A system in which a plurality of wireless terminals are connected to one wireless base station device is generally called a multiple access system (Multiple Access), a medium access control system (Medium Access Control), or the like, and the following systems have been proposed.
Demand assignment method (method of allocating resource on the basis of resource request of terminal)
Pure ALOHA method
Slot ALOHA method
CSMA/CA (Carrier Sense Multiple Access with Collision Avoidance)
Polling method

The demand assignment method is a method in which a wireless terminal issues a resource allocation request for a main signal when the wireless terminal wants to perform communication, and a resource management device that receives the resource allocation request allocates a resource to the wireless terminal to perform communication. The resource management device is referred to as a control station or a base station.

The pure ALOHA method is a communication protocol by wireless communication or satellite communication, and is a method in which a wireless terminal performs transmission at an arbitrary timing when the wireless terminal wants to perform communication. Each wireless terminal transmits data at an arbitrary timing the wireless terminal itself wants to transmit regardless of whether or not a wireless terminal other than itself is performing data transmission. For this reason, it is inevitable that a part of the transmitted signal overlaps transmission data from another wireless terminal and communication cannot be correctly performed, that is, a collision occurs. As the number of wireless terminals increases, the probability of collision increases, and as a result, the opportunity to correctly transmit data as a whole decreases. In general, it is known that the throughput of the pure ALOHA method is about 18% at the maximum. Therefore, the pure ALOHA method is considered to be suitable for applications in which one wireless terminal has few opportunities to transmit data or, if any, a small capacity of data is transmitted.

The slot ALOHA method is an improvement of the pure ALOHA method described above. While the pure ALOHA method permits transmission at an arbitrary timing, the slot ALOHA method provides time slots at regular intervals to control the transmission timing. It is known that the throughput of the slot ALOHA method is 368, which is twice the throughput of the pure ALOHA method.

The CSMA/CA scheme is a multiple access scheme used in layer 2 of the wireless LAN. In this scheme, the wireless terminal attempts to receive data once before transmitting the data, and checks whether another wireless terminal is transmitting the data. Then, when the other wireless terminal does not transmit data, the wireless terminal transmits its own data. On the other hand, if another wireless terminal is performing data transmission, the wireless terminal waits for the transmission until the data transmission is completed. Then, when the end of transmission is confirmed, data transmission is further performed after waiting for a random time.

The polling method is a method in which the wireless base station device becomes a so-called “order-taker”, selects a wireless terminal one by one, and checks the presence or absence of data desired to be transmitted. This method is suitable for applications such as terminal normality confirmation (health check) for a wireless terminal and data collection for each certain period. However, the operation of polling for the wireless terminal that does not need to transmit data is useless work.

The above systems are classified as follows from the viewpoint of “whether or not a terminal to which data transmission is intended takes some action”.

(1) Method in which Terminal Wanting to Perform Data Communication Causes Some Action
Demand assignment method
Pure ALOHA method
Slot ALOHA method
CSMA/CA
   (2) Method in which Terminal does not Take Action
Polling method

In a case where a very large number of wireless terminals are accommodated in one wireless base station device, it is desired to effectively use limited communication resources without wasting as much as possible. From the viewpoint of effective use of communication resources, in a system in which a wireless terminal that desires data communication takes some action, data desired to be transmitted is reliably present in the wireless terminal. However, in the pure ALOHA method and the slot ALOHA method, since the maximum throughput is 18% and 36%, respectively, more than half of resources are theoretically wasted. Therefore, these methods are not appropriate from the viewpoint of effective use of communication resources.

The demand assignment method and the polling method are methods in which a wireless base station device accommodating wireless terminals performs resource management in a single centralized manner. However, in the demand assignment method, since the sequence of the resource allocation request runs before the data transmission, the timing of the data transmission is slightly delayed, and the resource is wasted for that time. In the polling method, the wireless base station device performs “order-taker” regardless of whether or not the wireless terminal transmits data, and resources are secured in preparation for a case where there is transmission data. Polling processing to a wireless terminal having no transmission data wastes resources.

The wireless communication system described above includes a wireless LAN system such as a public wireless LAN system or an intra-company wireless LAN system, and a system that connects a mobile phone base station and a terminal in 4G and 5G mobile phone services. Furthermore, the wireless communication system also includes a satellite IoT system in which a base station function is mounted on a high altitude platform station (HAPS) or a low earth orbit satellite (LEO) and monitoring information is collected from a large number of sensor terminals.

Hereinafter, a public wireless LAN system which is one form of a wireless communication system will be described. The public wireless LAN system includes one wireless LAN controller, a plurality of wireless LAN access points, and an IP network. The wireless LAN controller corresponds to a control device in the wireless communication system described above, and the wireless LAN access point corresponds to a wireless base station device in the wireless communication system. The wireless LAN controller is connected to a plurality of wireless LAN access points via an IP network. The wireless LAN controller has a function of monitoring and controlling a plurality of wireless LAN access points.

There are a plurality of types of public wireless LAN systems depending on differences in configurations and functions thereof. A first type is a system that does not require a user authentication process based on a user operation when using a public wireless LAN service among systems that provide a public wireless LAN service in a station premise or a platform of a railway. Hereinafter, this is referred to as a “railway type”. The railway type is a SIM authentication method in a public wireless LAN service provided by a mobile phone provider. Since the user authentication is completed by the SIM information of the mobile phone, the user can automatically connect to the Internet only by moving near the wireless LAN access point. (See Non Patent Literature 1).

A second type is a system that provides a public wireless LAN service in a hot spot. Hereinafter, this is referred to as a “hot spot type”. Unlike the railway type, the hot spot type requires a user authentication process based on a user operation such as web authentication when using a public wireless LAN service (see Non Patent Literature 2).

A third type is a system that provides a public wireless LAN service in a hamburger shop, a convenience store, or the like. Hereinafter, this is referred to as a “convenience store type”. In the convenience store type, in addition to the screen for user authentication for Internet connection, there is also a customer service screen that provides a store's unique incentive such as a discount coupon (see Non Patent Literature 3).

In the conventional public wireless LAN system, the SSID of the connected wireless LAN access point has been stored in the wireless LAN slave device that has ever once connected to the public wireless LAN service. When receiving the beacon signal transmitted by the wireless LAN access point, the wireless LAN slave device starts connection to the wireless LAN access point regardless of the presence or absence of transmission data in the wireless LAN slave device. Then, the process finally proceeds to a point where the IP address is dispensed from the wireless LAN access point. Describing for each type, in the railway type, when the wireless LAN slave device approaches the vicinity of the wireless LAN access point, the processing proceeds to a state in which Internet connection can be used. In the hot spot type and the convenience store type, the IP address assignment processing to the wireless LAN slave device is completed, and further, in the convenience store type, the web browser automatically opens and the processing proceeds to the display of the service screen.

The above processing is executed when the wireless LAN slave device approaches the vicinity of the wireless LAN access point regardless of whether or not the user who owns the wireless LAN slave device actually wants to actively connect to the public wireless LAN service. Taking the convenience store type as an example, in a case where the convenience store faces a busy street, as far as the radio wave of the wireless LAN reaches, the IP address is dispensed to the wireless LAN slave device of the person who has simply passed nearby. In addition, the IP address is also dispensed to the wireless LAN slave device of the user who has entered the convenience store but does not actively use the public wireless LAN service.

As described above, in the conventional public wireless LAN system, the IP address is automatically assigned to the wireless LAN slave device of the user who does not actively use the public wireless LAN service, and the IP address resources are wastefully consumed. A particular problem is that the DHCP server of the wireless LAN access point has a limitation on the number of IP addresses that can be dispensed to the wireless LAN slave device. In this case, the IP address is depleted, and there is a possibility that the IP address cannot be assigned to the wireless LAN slave device of the user who wants to actively use the public wireless LAN service.

### CITATION LIST

### Non Patent Literature

Non Patent Literature 1: “How to Connect on a Smartphone or Tablet”, [searched on Feb. 26, 2021], the Internet <https://www.nttdocomo.co.jp/service/d_wifi/usage_smt.html>
Non Patent Literature 2: “How to Connect on PCs and Other Wi-Fi Compatible Devices”, [searched on Feb. 26, 2021], the Internet <https://www.nttdocomo.co.jp/service/d_wifi/usage_pc.html>
Non Patent Literature 3: “Seven eleven apuri kara muryo Wi-Fi (seven spot) ni setsuzoku suru tejun (Procedure for Connecting to Free Wi-Fi (Seven Spot) from Seven-eleven App”, [searched on Feb. 26, 2021], the Internet <https://sumahosupportline.com/wifi-connection-from-the-seven-eleven-app-to-the-seven-spot/>

### SUMMARY OF INVENTION

### Technical Problem

In a wireless communication system such as a public wireless LAN system, the number of wireless terminals accommodated by one wireless base station device (wireless LAN access point) is enormous. However, since there is a limit to the communication resources allocated to one wireless base station device, it is desirable to suppress the allocation of the communication resources to the wireless terminal (wireless LAN slave device) that does not need to communicate as much as possible and to effectively use the limited communication resources.

More specifically, in the conventional public wireless LAN system, a useless IP address is dispensed to the wireless LAN slave device of the user who does not actively use the public wireless LAN service. In view of such a current situation, it is desirable to suppress useless IP address dispersing to the wireless LAN slave device of the user who simply passes by and does not actively use the service. By doing so, it is desired to avoid a situation in which a user who really wants to connect to the public wireless LAN service cannot receive the service due to the exhaustion of the IP address as much as possible.

The present disclosure has been made in view of the above circumstances, and an object of the present disclosure is to provide a technique capable of effectively using limited communication resources.

### Solution to Problem

The present disclosure provides a wireless base station device in order to achieve the above object. The wireless base station device of the present disclosure is configured to execute the following processing. In the first processing, in response to the reception of the radio wave from the wireless terminal, the wireless base station device of the present disclosure determines the active utilization of the wireless communication service by the wireless terminal on the basis of the past connection record information of the wireless terminal. The second processing is a process in a case where the wireless terminal is a terminal that cannot expect active use of the wireless communication service. In the second processing, the wireless base station device of the present disclosure allocates a communication resource to the wireless terminal under a condition of a predetermined connection operation by the wireless terminal. The third processing is a process in a case where the wireless terminal is a terminal that can expect active use of the wireless communication service. In the third processing, the wireless base station device of the present disclosure allocates a communication resource to the wireless terminal without a condition of the above-described predetermined connection operation.

The present disclosure provides a wireless communication system in order to achieve the above object. The wireless communication system according to the present disclosure is a wireless communication system in which a wireless base station device and a control device that manages the wireless base station device are connected via a communication network. The wireless communication system of the present disclosure is configured to execute the following processing. In the first processing, in response to the wireless base station device receiving of the radio wave from the wireless terminal, the wireless communication system of the present disclosure determines the active utilization of the wireless communication service by the wireless terminal on the basis of the past connection record information of the wireless terminal accumulated in the wireless base station device or the control device. The second processing is a process in a case where the wireless terminal is a terminal that cannot expect active use of the wireless communication service. In the second processing, the wireless communication system of the present disclosure allocates a communication resource from the wireless base station device to the wireless terminal under a condition of a predetermined connection operation by the wireless terminal. The third processing is a process in a case where the wireless terminal is a terminal that can expect active use of the wireless communication service. In the third processing, the wireless communication system of the present disclosure allocates a communication resource from the wireless base station device to the wireless terminal without a condition of the predetermined connection operation.

Furthermore, the present disclosure provides a wireless communication method in order to achieve the above object. A wireless communication method of the present disclosure is a wireless communication method by a wireless base station device. The wireless communication method of the present disclosure includes the following steps. The first step is a step of determining, in response to the reception of the radio wave from the wireless terminal, the active utilization of the wireless communication service by the wireless terminal on the basis of the past connection record information of the wireless terminal. The second step is a step of allocating a communication resource to the wireless terminal under a condition of a predetermined connection operation by the wireless terminal when the wireless terminal is a terminal that cannot expect active use of the wireless communication service. The third step is a step of allocating a communication resource to the wireless terminal without a condition of the above-described predetermined connection operation when the wireless terminal is a terminal that can expect active use of the wireless communication service.

### Advantageous Effects of Invention

According to the wireless base station device, the wireless communication system, and the wireless communication method according to the present disclosure, limited communication resources can be effectively used.

### BRIEF DESCRIPTION OF DRAWINGS

FIG. 1 is a diagram illustrating a configuration of a public wireless LAN system common to each embodiment of the present disclosure.

FIG. 2 is a block diagram illustrating a configuration of a convenience store type wireless LAN access point according to the first embodiment of the present disclosure.

FIG. 3 is a table illustrating an example of a processing log by the wireless LAN access point illustrated in FIG. 2.

FIG. 4 is a table illustrating an example of connection record information by the wireless LAN access point illustrated in FIG. 2.

FIG. 5 is a diagram for explaining a relationship between a processing log and connection record information.

FIG. 6 is a diagram for explaining an example of conversion from a processing log to connection record information by the wireless LAN access point illustrated in FIG. 2.

FIG. 7 is a flowchart illustrating a state transition of a wireless LAN slave device in the public wireless LAN system according to the first embodiment of the present disclosure.

FIG. 8 is a flowchart illustrating a connection flow of the wireless LAN slave device to the wireless LAN access point according to the first embodiment of the present disclosure (allocation flow by active utilization of the terminal).

FIG. 9 is a flowchart illustrating a connection flow of the wireless LAN slave device to the wireless LAN access point according to the first embodiment of the present disclosure (flow in a case where the terminal can expect active use).

FIG. 10 is a flowchart illustrating a connection flow of the wireless LAN slave device to the wireless LAN access point according to the first embodiment of the present disclosure (flow in a case where the terminal cannot expect active use).

FIG. 11 is a block diagram illustrating a configuration of a hot spot type wireless LAN access point according to the second embodiment of the present isclosure.

FIG. 12 is a table illustrating an example of a processing log by the wireless LAN access point illustrated in FIG. 11.

FIG. 13 is a diagram for explaining an example of conversion from a processing log to connection record information by the wireless LAN access point illustrated in FIG. 11.

FIG. 14 is a flowchart illustrating a state transition of a wireless LAN slave device in the public wireless LAN system according to the second embodiment of the present disclosure.

FIG. 15 is a flowchart illustrating a connection flow of the wireless LAN slave device to the wireless LAN access point according to the second embodiment of the present disclosure (allocation flow by active utilization of the terminal).

FIG. 16 is a flowchart illustrating a connection flow of the wireless LAN slave device to the wireless LAN access point according to the second embodiment of the present disclosure (flow in a case where the terminal can expect active use).

FIG. 17 is a flowchart illustrating a connection flow of the wireless LAN slave device to the wireless LAN access point according to the second embodiment of the present disclosure (flow in a case where the terminal cannot expect active use).

FIG. 18 is a block diagram illustrating a configuration of a railway type wireless LAN access point according to the third embodiment of the present disclosure.

FIG. 19 is a table illustrating an example of a processing log by the wireless LAN access point illustrated in FIG. 18.

FIG. 20 is a diagram for explaining an example of conversion from a processing log to connection record information by the wireless LAN access point illustrated in FIG. 18.

FIG. 21 is a flowchart illustrating a state transition of a wireless LAN slave device in the public wireless LAN system according to the third embodiment of the present disclosure.

FIG. 22 is a flowchart illustrating a connection flow of the wireless LAN slave device to the wireless LAN access point according to the third embodiment of the present disclosure (allocation flow by active utilization of the terminal).

FIG. 23 is a flowchart illustrating a connection flow of the wireless LAN slave device to the wireless LAN access point according to the third embodiment of the present disclosure (flow in a case where the terminal can expect active use).

FIG. 24 is a flowchart illustrating a connection flow of the wireless LAN slave device to the wireless LAN access point according to the third embodiment of the present disclosure (flow in a case where the terminal cannot expect active use).

FIG. 25 is a diagram illustrating an example of a hardware configuration of a wireless LAN access point common to each embodiment of the present disclosure.

### DESCRIPTION OF EMBODIMENTS

### 1. Configuration of Public Wireless LAN System Common to Each Embodiment

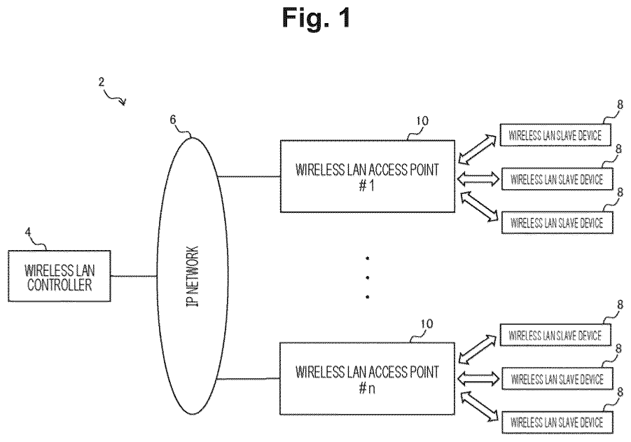

At first, a configuration of a public wireless LAN system common to each embodiment of the present disclosure will be described with reference to FIG. 1. A public wireless LAN system 2 includes one wireless LAN controller 4, a plurality of (n) wireless LAN access points 10, and an IP network 6, and provides a public wireless LAN service (wireless communication service) to a user of a wireless LAN slave device 8. The wireless LAN access point 10 is a wireless base station device that accommodates a large number of wireless LAN slave devices 8 that are wireless terminals. The IP network 6 is a communication network that connects the wireless LAN controller 4 and the plurality of wireless LAN access points 10. The wireless LAN controller 4 has a function as a control device for monitoring and controlling the plurality of wireless LAN access points 10.

Each embodiment described below is different in the configuration and function of the wireless LAN access point 10. The wireless LAN access point 10 according to the first embodiment is a convenience store type wireless LAN access point. The wireless LAN access point 10 according to the second embodiment is a hot spot type wireless LAN access point. In addition, the wireless LAN access point 10 according to the third embodiment is a railway type wireless LAN access point. In the following description, when it is necessary to distinguish the three types of the wireless LAN access point 10, the convenience store type is referred to as a wireless LAN access point 10A, the hot spot type is referred to as a wireless LAN access point 10B, and the railway type is referred to as a wireless LAN access point 10C.

### 2. Wireless LAN Access Point According to First Embodiment

### (Convenience Store Type)

### 2-1. Configuration of Wireless LAN Access Point

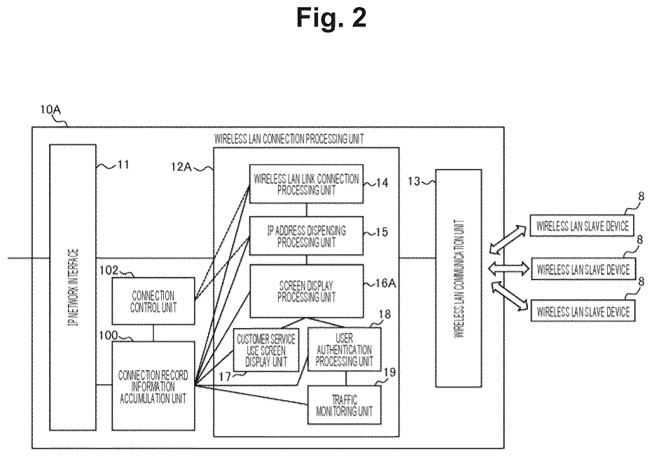

FIG. 2 is a block diagram illustrating a configuration of a convenience store type wireless LAN access point 10A according to the first embodiment. The wireless LAN access point 10A includes an IP network interface 11, a wireless LAN connection processing unit 12A, a wireless LAN communication unit 13, a connection record information accumulation unit 100, and a connection control unit 102.

The IP network interface 11 is an interface for transmitting and receiving a monitoring control signal and transmitting and receiving main signal traffic of the wireless LAN slave device 8 between the wireless LAN access point 10A and the wireless LAN controller 4. The wireless LAN communication unit 13 is a device for the wireless LAN access point 10A to transmit and receive radio waves of a wireless LAN. The wireless LAN communication unit 13 includes an antenna (not illustrated) and performs wireless communication with the plurality of wireless LAN slave devices 8.

The wireless LAN connection processing unit 12A performs processing when the wireless LAN slave device 8 is connected to the wireless LAN access point 10A. The wireless LAN connection processing unit 12A includes a wireless LAN link connection processing unit 14, an IP address dispensing processing unit 15, a screen display processing unit 16A, a customer service use screen display unit 17, a user authentication processing unit 18, and a traffic monitoring unit 19.

After receiving the radio wave emitted from the wireless LAN slave device 8, the wireless LAN link connection processing unit 14 attempts to establish a wireless LAN link with the wireless LAN slave device 8. Then, in response to the establishment of the wireless LAN link with the wireless LAN slave device 8, the wireless LAN link connection processing unit 14 transfers the processing to the IP address dispensing processing unit 15.

The IP address dispensing processing unit 15 dispenses the IP address to the wireless LAN slave device 8 for which the wireless LAN link is established. The IP address is a communication resource that the wireless LAN access point 10A includes. A predetermined number of IP addresses are assigned to the wireless LAN access point 10A in advance. The IP address dispensing processing unit 15 dispenses one of the IP addresses assigned to the wireless LAN access point 10A to the wireless LAN slave device 8 on the basis of the DHCP protocol. Upon completion of this process normally, the IP address dispensing processing unit 15 transfers the processing to the screen display processing unit 16A in the next step.

The screen display processing unit 16A displays a screen for customer service or a user authentication screen necessary for Internet connection by a public wireless LAN service on a web browser mounted on the wireless LAN slave device 8. In response to the operation for using the customer service being performed by the user operation, the screen display processing unit 16A transfers the processing to the customer service use screen display unit 17. In addition, in response to the operation for user authentication being performed by the user operation, the screen display processing unit 16A transfers the processing to the user authentication processing unit 18.

The customer service use screen display unit 17 displays a screen for the user to use the customer service provided in the store where the wireless LAN access point 10A is installed. As the customer service, for example, a store's own incentive such as a discount coupon can be exemplified. For example, the user can receive a predetermined customer service such as a discount service by showing the customer service use screen displayed on the wireless LAN slave device 8 to the clerk.

The user authentication processing unit 18 performs authentication processing for performing Internet connection using a public wireless LAN service. When the authentication using the user ID and the user authentication password for the public wireless LAN service is appropriately performed, the wireless LAN slave device 8 becomes possible to be connected to the Internet.

The traffic monitoring unit 19 monitors how much actual user traffic has flowed after Internet connection of the wireless LAN slave device 8 becomes possible. Specifically, a main signal traffic amount for each wireless LAN slave device 8 is monitored.

Moreover, in the above-described conventional public wireless LAN system, an IP address is dispensed to the wireless LAN slave device 8 that does not actively use the public wireless LAN service, resulting in the waste of communication resources. Therefore, the wireless LAN access point 10A has a mechanism for determining whether or not the wireless LAN slave device 8 actively uses the public wireless LAN service and controlling the connection processing with respect to the wireless LAN slave device 8 on the basis of the determination result. The mechanisms are the connection record information accumulation unit 100 and the connection control unit 102.

The connection record information accumulation unit 100 accumulates “connection record information” obtained by processing the “processing log” of the wireless LAN access point 10A when the wireless LAN slave device 8 is connected to the wireless LAN access point 10A. The contents of the “processing log” and the “connection record information” will be described in detail later. The information accumulated in the connection record information accumulation unit 100 is aggregated in the wireless LAN controller 4.

The connection control unit 102 refers to the information of the connection record information accumulation unit 100 and determines whether or not the user of the wireless LAN slave device 8 connected to the wireless LAN access point 10A is an active public wireless LAN user. Further, by referring to the information aggregated in the wireless LAN controller 4, the connection control unit 102 can know the connection record status of the wireless LAN slave device 8 connected to the wireless LAN access point 10A for the first time with respect to another wireless LAN access point. The connection control unit 102 controls the processing performed by the wireless LAN connection processing unit 12A on the basis of the determination result of active utilization determination.

Specifically, the connection control unit 102 controls the wireless LAN link connection processing unit 14 and the IP address dispensing processing unit 15 connected by a broken line in FIG. 2. For example, the connection control unit 102 causes the wireless LAN link connection processing unit 14 not to establish the wireless LAN link unless the radio wave reach power from the wireless LAN slave device 8 reaches a certain level. In addition, the connection control unit 102 causes the IP address dispensing processing unit 15 not to dispense the IP address even though the wireless LAN link is established, or sets different IP address dispensing times for each MAC address of the wireless LAN slave device 8.

### 2-2. Details of Connection Record Information

### 2-2-1. Description of Processing Log

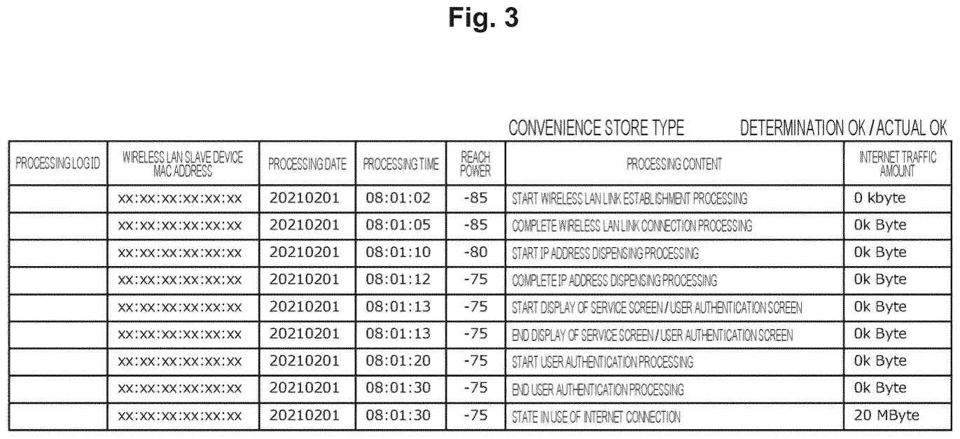

As illustrated in the table of FIG. 3, the “processing log” is a log of what processing the wireless LAN access point 10A has performed on the wireless LAN slave device 8 from the start to the end of the connection of the wireless LAN slave device 8 with the wireless LAN access point 10A. Specifically, the “processing log” includes the following information.
Processing log ID
Wireless LAN slave device MAC address
Processing date
Processing time
Reach power
Processing content
Internet traffic amount

The “processing log ID” is an ID of a log to be recorded when the wireless LAN access point 10A performs some processing on the wireless LAN slave device 8. The log ID is a unique ID in the wireless LAN access point 10A. The processing log may be a serial number, or may be a character string obtained by combining the date+time+wireless LAN slave device MAC address.

The “wireless LAN slave device MAC address” is a MAC address of the wireless LAN slave device 8 to which the wireless LAN access point 10A has performed some processing.

The “processing date” is a date on which the wireless LAN access point 10A performs some processing, and the “processing time” is a time at which the wireless LAN access point 10A performs some processing. A specific content of the processing is described in “Processing content”.

The “reach power” is the reach power of the wireless LAN slave device 8 at the time when the wireless LAN access point 10A performs some processing. A specific content of the processing is described in “Processing content”.

“Processing content” indicates a state transition based on processing in the wireless LAN connection processing unit 12A of the wireless LAN access point 10A. In the flow in which the wireless LAN slave device 8 is connected to the wireless LAN access point 10A, the “processing content” is one of the following.
Start wireless LAN link connection processing
End wireless LAN link connection processing
Start IP address dispensing processing
End IP address dispensing processing
Start display processing of service screen/user authentication screen
End display processing of service screen/user authentication screen
Start display of customer service use screen
End display of customer service use screen
State in use of customer service
Start user authentication processing
End user authentication processing
State in use of internet connection
Start IP address return processing
Complete IP address return processing

The “Internet traffic amount” is a traffic amount actually communicated by the wireless LAN slave device 8 after the wireless LAN slave device 8 enters the “State in use of Internet connection”. Whether the wireless LAN slave device 8 in the “State in use of internet connection” actively uses the Internet or whether the wireless LAN slave device 8 is simply automatically in the “State in use of internet connection” can be distinguished from the traffic amount.

### 2-2-2. Description of Connection Record Information

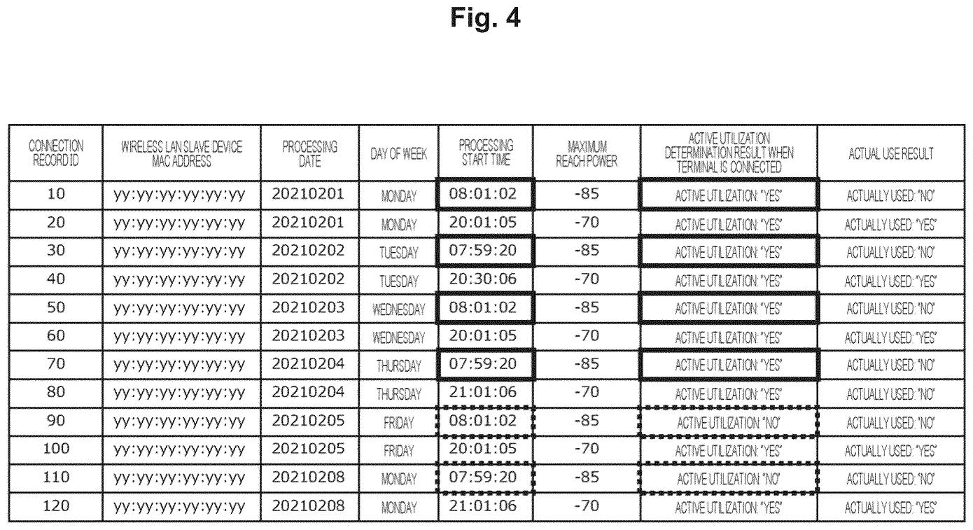

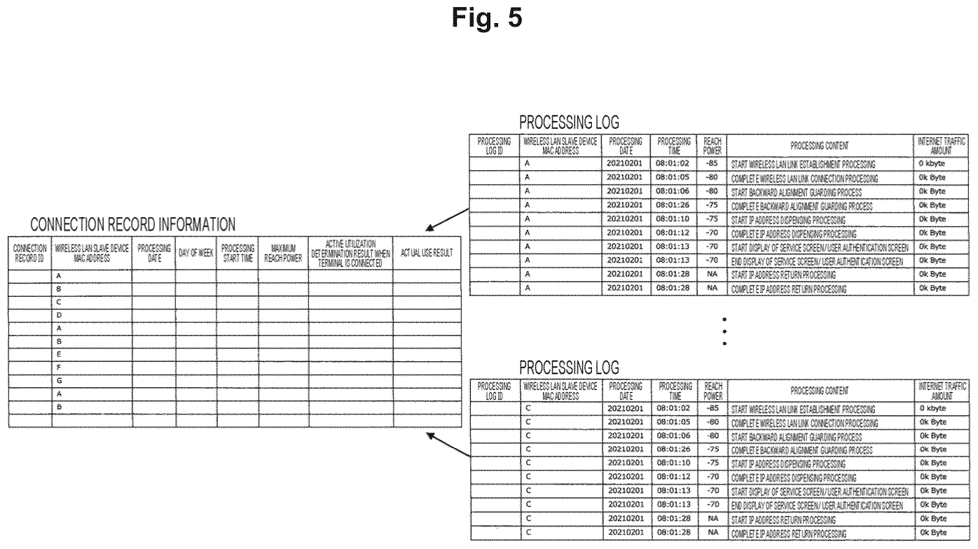

As illustrated in FIG. 4, the “connection record information” is a table in which the following information is extracted from the “processing log” described above and put together in one row for each connection record. More specifically, as illustrated in FIG. 5, the “connection record information” of the wireless LAN access point 10 is obtained by extracting the following information from the “processing logs” of all the wireless LAN slave devices 8 connected to the wireless LAN access point 10 and arranging them in time series.
Connection record ID
Wireless LAN slave device MAC address
Processing date
Day of week
Processing start time
Maximum reach power
Active utilization determination result when wireless LAN slave device is connected
Actual use result

The “connection record ID” is an ID unique to the connection record information. For example, when the same wireless LAN slave device 8 connects to the same wireless LAN access point 10A at different times on the same day, different “connection record IDs” are allocated.

The “wireless LAN slave device MAC address” is a MAC address of the wireless LAN slave device 8 that is connected to the wireless LAN access point 10A.

The “processing date” is a date on which the wireless LAN access point 10A detects a reached radio wave and starts processing with respect to the wireless LAN slave device 8 having the “wireless LAN slave device MAC address”.

The “day of week” is information obtained from the above processing date. The “day of week” is used as a material for enhancing the accuracy of the active utilization determination in consideration of the tendency due to the difference in the day of the week in the active utilization determination of the wireless LAN slave device 8.

The “maximum reach power” is the maximum value of the “reach power” from the wireless LAN slave device 8 in the wireless LAN access point 10A described in the processing log. The “maximum reach power” is used to calculate the threshold of the reach power level in order to eliminate in advance the processing for the wireless LAN slave device 8 that does not reach a certain level of reach power when performing the connection processing for the wireless LAN slave device 8.

The “active utilization determination result when the wireless LAN slave device is connected” takes a value of either “Active utilization: Yes” or “Active utilization: No”. The active utilization determination is made on the basis of past “connection record information” accumulated in the wireless LAN access point 10A and “connection record information” of another wireless LAN access point 10A accumulated in the wireless LAN controller 4. The wireless LAN access point 10A unconditionally performs a wireless LAN link connection processing and dispenses an IP address to the wireless LAN slave device 8 determined as “Active utilization: Yes”. On the other hand, the wireless LAN access point 10A performs a processing not to dispense the IP address as much as possible to the wireless LAN slave device 8 determined as “Active utilization: No”. A method of determining the active utilization determination will be described later.

The “Actual use result” takes a value of either “Actually used: Yes” or “Actually used: No”. The “Actually used: Yes” is a case where the wireless LAN slave device 8 that has received the IP address dispensed has performed some communication such as Internet communication. In the case of use at a convenience store, the IP address dispensed from the wireless LAN access point 10A may be used for use of customer service, such as acquisition of in-store use coupons, instead of using the Internet. However, even in such a case, since the dispensed IP address is not useless, it is determined that “Actually used: Yes”. Note that, if the Internet is used, the amount of Internet traffic is generated, and this information can be detected by the wireless LAN access point 10A, and thus, it is a material for determining whether there is actual use or not. In addition, in the convenience store type (and hot spot type described later), a certain terminal operation is required by the user himself/herself at the time of using the Internet, and thus, the presence or absence of this operation is also a material for determining whether there is actual use or not.

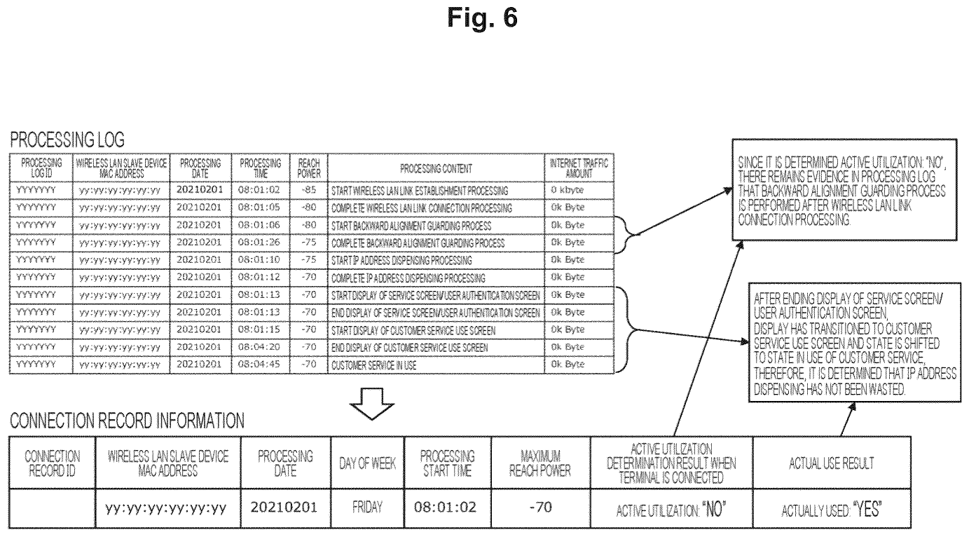

Next, conversion from the processing log to the connection record information by the wireless LAN access point 10A will be described with reference to FIG. 6. FIG. 6 is a diagram specifically illustrating a conversion example from the processing log to the connection record information.

In the example illustrated in FIG. 6, the processing log still indicates that the wireless LAN slave device 8 having the MAC address “yy:yy:yy:yy:yy:yy” is connected to the wireless LAN access point 10A on Friday, Feb. 1, 2021, and the processing is started at 8:01:02 AM. The maximum reach power at the time of terminal connection remaining in the processing log is −70 dBm. These pieces of information are directly used as connection record information.

In the example illustrated in FIG. 6, there remains evidence in the processing log that the backward alignment guarding process described later is performed after the wireless LAN link connection processing. In a case where the backward alignment guarding process is performed, the active utilization determination result at the time of terminal connection in the connection record information is “Active utilization: No”. In addition, in the processing log, there remains evidence that the display has transitioned to the customer service use screen and the state is shifted to the state in use of the customer service. Judging from this, it can be determined that the dispensed IP address has not been useless, and the actual use result in the connection record information is “Actually used: Yes”.

### 2-3. State of Wireless LAN Slave Device

As described above, the connection record information accumulated in the wireless LAN access point 10A and the wireless LAN controller 4 includes the actual use result of the Internet or the customer service by the wireless LAN slave device 8 that has received the IP address dispensed. Whether the wireless LAN slave device 8 uses the Internet or customer service is determined from the “state” of the wireless LAN slave device. In the relationship with the wireless LAN access point 10A, the “state” of the wireless LAN slave device 8 is defined as follows.
State of “Link unestablished”
State of “Link established”
State of “IP address assigned”
State “in use of Internet connection”
State “in use of customer service”

The state of “link unestablished” is a state in which a link in layer 2 between the wireless LAN slave device 8 and the wireless LAN access point 10A is not established. All the wireless LAN slave devices 8 that attempt connection are treated as being in the state of “link unestablished”.

The state of “link established” is a state in which the wireless LAN link establishment processing between the wireless LAN slave device 8 and the wireless LAN access point 10A is completed.

The state of “IP address assigned” is a state in which the IP address dispensing processing from the wireless LAN access point 10A to the wireless LAN slave device 8 is completed. The wireless LAN slave device 8 in this state is in a state capable of IP communication.

The state “in use of Internet connection” is a state in which Internet traffic is generated, for example, the user operates the wireless LAN slave device 8 to browse the web, or the like. In the case of transition to “in use of Internet connection”, the actual use value of the connection record information is “Actually used: Yes”.

The state “in use of customer service” is a state in which the user uses the wireless LAN slave device 8 to acquire a coupon or the like at a convenience store or the like. In the case of transition to the state “in use of customer service”, similarly to the state “in use of Internet connection”, the actual use value of the connection record information is “Actually used: Yes”.

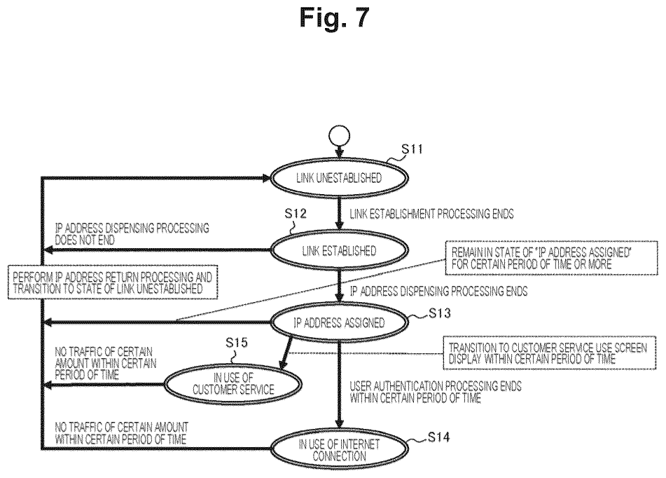

The “state” of the wireless LAN slave device 8 defined as described above transitions as illustrated in FIG. 7 when the wireless LAN slave device 8 is connected to the wireless LAN access point 10A. FIG. 7 is a flowchart illustrating a state transition of a wireless LAN slave device 8 in the relationship with the wireless LAN access point 10A.

At the time of connection to the wireless LAN access point 10A, any of the wireless LAN slave device 8 is initially in the state of “link unestablished” (step S11). When the link establishment processing ends, the wireless LAN slave device 8 enters the state of “link established” (step S12).

In a case where the IP address dispensing processing from the wireless LAN access point 10A to the wireless LAN slave device 8 does not end in the state of “link established”, the wireless LAN slave device 8 enters the state of “link unestablished” again (step S11).

In a case where the IP address dispensing processing from the wireless LAN access point 10A to the wireless LAN slave device 8 is ended in the state of “link established”, the wireless LAN slave device 8 enters the state of “IP address assigned” (step S13).

After entering the state of “IP address assigned”, in a case where the state remains in the state of “IP address assigned” for more than a certain period of time, that is, in a case where the user authentication processing is not performed and the screen display does not transition to the customer service use screen display, the IP address return processing is performed on the wireless LAN slave device 8. As a result, the wireless LAN slave device 8 enters the state of “link unestablished” again (step S11).

When the user authentication processing is completed in the wireless LAN slave device 8 within a certain period of time after entering the state of “IP address assigned”, the wireless LAN slave device 8 enters the state “in use of Internet connection” (step S14).

After entering the state “in use of Internet connection”, in a case where there is no traffic of a certain amount within a certain period of time, that is, in a case where the usage record of the public wireless LAN service by the wireless LAN slave device 8 is less than the reference record, the IP address return processing is performed on the wireless LAN slave device 8. As a result, the wireless LAN slave device 8 enters the state of “link unestablished” again (step S11).

Further, when the screen display of the wireless LAN slave device 8 transitions to the customer service use screen display within a certain period of time after entering the state of “IP address assigned”, the wireless LAN slave device 8 enters the state “in use of customer service” (step S15).

After entering the state “in use of customer service”, in a case where there is no traffic of a certain amount within a certain period of time, that is, in a case where the usage record of the public wireless LAN service by the wireless LAN slave device 8 is less than the reference record, the IP address return processing is performed on the wireless LAN slave device 8. As a result, the wireless LAN slave device 8 enters the state of “link unestablished” again (step S11).

### 2-4. Description of Active Utilization Determination

### 2-4-1. Active Utilization Determination Using Connection Record Information

In order to avoid useless dispensing of IP address, which is a limited communication resource, it is ideal to perform the IP address dispensing processing only for the wireless LAN slave device 8 transitioning to the state “in use of Internet connection” or the state “in use of customer service”. However, it is unknown whether the wireless LAN slave device 8 finally transitions to the state “in use of Internet connection” or the state “in use of customer service” before connection to the wireless LAN access point 10A.

Therefore, the wireless LAN access point 10A determines the possibility of the transition of the wireless LAN slave device 8 to the state “in use of Internet connection” or the state “in use of customer service” on the basis of the connection record information described above. Then, to the wireless LAN slave device 8 determined to have a high possibility of transition to the state “in use of Internet connection” or the state “in use of customer service”, the IP address dispensing processing is performed with the determination of “Active utilization: Yes”. On the other hand, for the wireless LAN slave device 8 that tends not to transition to the state “in use of Internet connection” or the state “in use of customer service”, the IP address is prevented from being dispensed with the determination of “Active utilization: No”.

The following is a specific example of the active utilization determination of the wireless LAN slave device 8 using the past connection record information accumulated in the wireless LAN access point 10A.

### (Determination Method 1) Active Utilization Determination Method of Wireless LAN Slave Device Having No Accumulation of Connection Record Information

The wireless LAN slave device 8 having no past connection record information accumulated in the wireless LAN access point 10A is the wireless LAN slave device 8 that has been connected for the first time. In this case, the wireless LAN access point 10A determines “Active utilization: Yes”. However, the wireless LAN controller 4 may be referred to, and the connection record information or the result of the active utilization determination in another wireless LAN access point 10A may be referred to.

### (Determination Method 2) Active Utilization Determination Method of Wireless LAN Slave Device Having Small Amount of Connection Record Information

For the wireless LAN slave device 8 having small amount of past connection record information accumulated in the wireless LAN access point 10A, the wireless LAN access point 10A determines “Active utilization: Yes”. In this case as well, the wireless LAN controller 4 may be referred to, and the connection record information or the result of the active utilization determination in another wireless LAN access point 10A may be referred to.

### (Determination Method 3) Active Utilization Determination Method of Wireless LAN Slave Device Having Relatively Large Amount of Connection Record Information

For the wireless LAN slave device 8 having relatively large amount of past connection record information accumulated in the wireless LAN access point 10A, the wireless LAN access point 10A performs the active utilization determination using a combination of the “active utilization determination result” and the “actual use result”. Specific examples of the active utilization determination by the determination method 3 will be listed below.

<Specific Example 1> If there is a case where it is determined as “Active utilization: Yes” but it has not been actually used, and if the case continues, the active utilization determination is changed to “Active utilization: No” from the next time.

<Specific Example 2> If there is a case where it is determined as “Active utilization: No” but it has been actually used, and if the case continues, the active utilization determination is changed to “Active utilization: Yes” from the next time.

<Specific Example 3> If there is a case where it is determined as “Active utilization: Yes” and it has been used but not in the morning from Monday to Friday, and if the case continues, the active utilization determination is changed to “Active utilization: No” from the next time.

<Specific Example 4> In Specific Example 3, even in the same wireless LAN slave device 8, the active utilization is determined on the basis of past connection record information for evening from Monday to Friday or for Saturday and Sunday.

In the specific examples 3 and 4 of the determination method 3, the accuracy of the active utilization determination is improved by the statistical tendency depending on the day of the week and the time. A more specific example thereof is illustrated in FIG. 4. In the example illustrated in FIG. 4, with the connection record IDs=10, 30, 50, and 70, the active utilization of the connection record information around 8:00 AM is “Yes” and the actual use result is “No”. In the night of the same date, although both the active utilization and the actual use result are “Yes”, the actual use is not performed in the morning four times in a row. Therefore, in the connection record ID=90 which is the connection record in the next morning, the active utilization is changed to “No”.

### 2-4-2. Active Utilization Determination by Category of User

Further, the wireless LAN access point 10A determines whether the active utilization is present/absent according to the category to which the user of the wireless LAN slave device 8 connected to the wireless LAN access point 10A belongs. The wireless LAN access point 10A is installed in a hamburger shop or a convenience store. The users of the wireless LAN slave devices 8 connected to the wireless LAN access point 10A can be classified into the following categories.
(1) User who does not enter store
   (1a) User who happens to pass near store
   (1b) User who stays near store and uses Internet connection
(2) User who enters store
   (2a) User who has come for shopping
      (2ai) User who merely does shopping
      (2aii) User who shops using customer service (free coupon acquisition or the like)
      (2aiii) User who uses Internet connection in store
   (2b) User who does not shop (use of bank ATM, use of toilet, etc.)

In the conventional public wireless LAN system, the IP address is dispensed from the wireless LAN access point to all the users. However, among the users described above, those who actually actively perform the IP communication are only the user (1b), the user (2aii), and the user (2aiii). The wireless LAN access point 10A according to the present embodiment distinguishes the user (1b), the user (2aii), and the user (2aiii) from other users by a method described below. Then, it is determined “Active utilization: Yes” only for the user who actually actively performs the IP communication.

First, as a general tendency, the person who enters the store tends to have stronger radio wave reach power to the wireless LAN access point 10A emitted by the wireless LAN slave device 8 than the person who does not enter the store. Therefore, by setting an appropriate threshold RX level threshold (RLTH) for the radio wave reach power, it is possible to distinguish the radio wave reach power emitted from the wireless LAN slave device 8 of the user who does not enter the store from the radio wave reach power emitted from the wireless LAN slave device 8 of the user who enters the store as follows.
Radio wave reach power to access point<RLTH . . . User who does not enter store
Radio wave reach power to access point≥RLTH . . . User who enters store

In addition, since the user (1a), the user (2ai), and the user (2b) who do not actively use the service remain without transitioning to the user authentication screen or the customer service use screen, they can be distinguished from the users who actively use the service in this respect. Note that whether the user (2a) who has entered the store and shopped can be the user (2ai), the user (2aii), or the user (2aiii) can be determined by the following method.
User who merely does shopping (2ai)
Stay on displaying service screen/user authentication screen
User who shops using customer service (2aii)
After the service screen/user authentication screen is displayed, the screen transitions to the customer service screen within Ta seconds which is a reference transition time to the customer service use screen
User who uses Internet connection (2aiii)
After the service screen/user authentication screen is displayed, the screen transitions to the public wireless LAN connection user authentication screen within Tb seconds which is a reference transition time to the user authentication screen

Each value of Ta and Tb is an upper limit of a time during which a person who actively uses the screen stays on displaying the service screen/user authentication screen. Therefore, by statistically processing these time values in various wireless LAN slave devices 8, it is possible to use the time (DHCP lease time) for assigning an IP address as an indicator.

### 2-5. Explanation of Communication Resource Allocation Method Based on Determination Result of Active Utilization

On the basis of the determination result of the active utilization determination performed as described above, the wireless LAN access point 10A allocates communication resources to the wireless LAN slave device 8, that is, dispenses an IP address. In the determination of whether or not the IP address can be dispensed, the following three parameters are used.
RLTH: reach power threshold to the wireless LAN access point 10A for determining whether or not the wireless LAN slave device 8 enters the store
Ta: reference transition time to the customer service screen, that is, time from display of the service screen/user authentication screen to transition of a majority of active use users to display of the customer service use screen
Tb: reference transition time to the user authentication screen, that is, time from display of the service screen/user authentication screen to transition of a majority of active use users to display of the user authentication processing

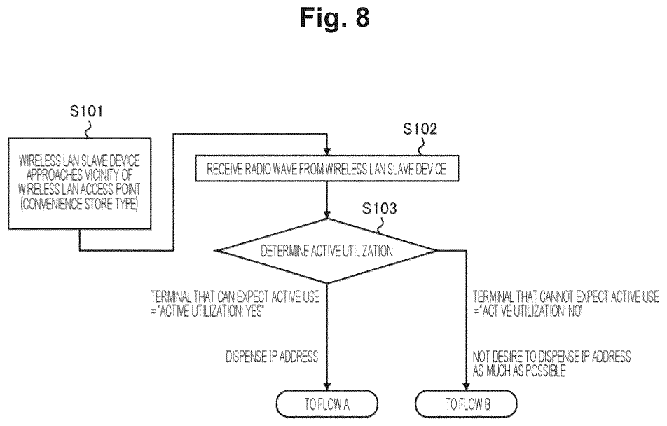

Hereinafter, the process of dispensing the IP address to the wireless LAN slave device 8 by the wireless LAN access point 10A will be described with reference to FIGS. 8 to 10. FIGS. 8 to 10 are flowcharts illustrating a connection flow of the wireless LAN slave device 8 to the wireless LAN access point 10A.

First, as illustrated in FIG. 8, in response to the wireless LAN slave device 8 approaching the vicinity of the wireless LAN access point 10A (step S101), the wireless LAN access point 10A receives a radio wave from the wireless LAN slave device 8 (step S102).

Upon receiving the radio wave from the wireless LAN slave device 8, the wireless LAN access point 10A performs the active utilization determination to determine whether or not the wireless LAN slave device 8 actively uses the public wireless LAN service on the basis of the accumulated connection record information (step S103). In addition to the connection record information accumulated in the wireless LAN access point 10A itself, the connection record information of another wireless LAN access point 10A accumulated in the wireless LAN controller 4 can also be used for the active utilization determination.

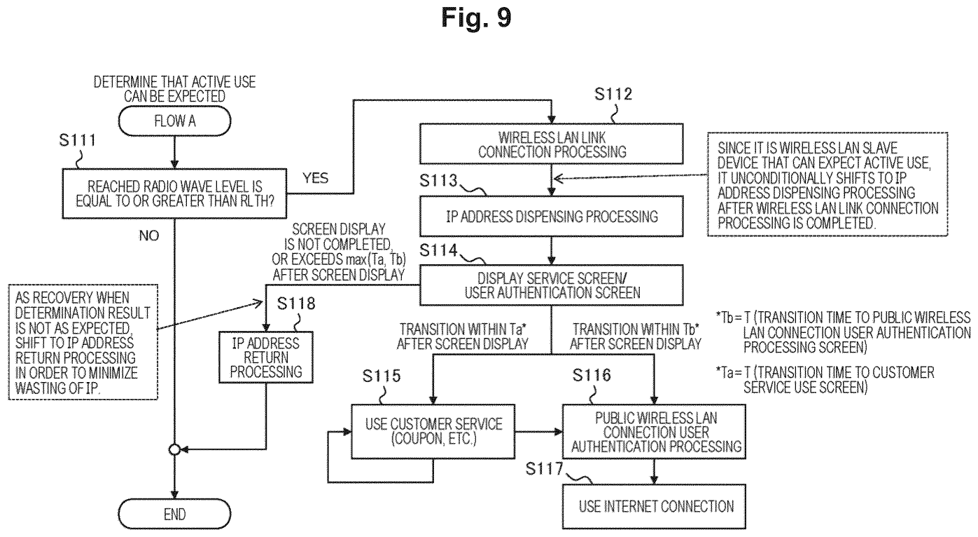

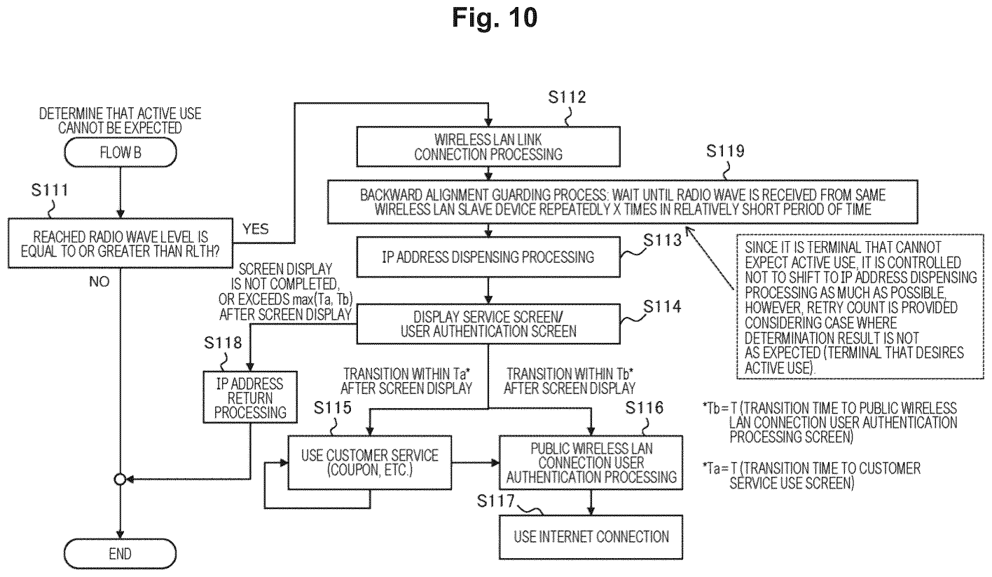

As a result of the active utilization determination, the IP address may be dispensed to the wireless LAN slave device 8 that is expected to actively use the public wireless LAN service. The process of connecting to the wireless LAN access point 10A is performed to the wireless LAN slave device 8 determined to have the active utilization by applying the flow A illustrated in FIG. 9. On the other hand, the IP address is not desired to be dispensed to the wireless LAN slave device 8 that is not expected to actively use the public wireless LAN service as much as possible. The process of connecting to the wireless LAN access point 10A is performed to the wireless LAN slave device 8 determined to have no active utilization by applying the flow B illustrated in FIG. 10.

A flow A applied to the wireless LAN slave device 8 that is expected to have active use from past connection record information will be described. As illustrated in FIG. 9, the wireless LAN access point 10A first determines whether or not the radio wave reach power from the wireless LAN slave device 8 is equal to or greater than RLTH (step S111). The wireless LAN access point 10A does not perform processing on the wireless LAN slave device 8 whose radio wave reach power is less than RLTH. This is because a user who is expected to have active use should approach the wireless LAN access point 10A.

When the radio wave reach power is equal to or higher than RLTH, the wireless LAN access point 10A performs a wireless LAN link connection processing for the wireless LAN slave device 8 (step S112). Since the wireless LAN slave device 8 that is subjected to the wireless LAN link connection processing is a terminal that can expect active use, the wireless LAN access point 10A directly shifts to the IP address dispensing processing when the wireless LAN link connection processing is completed (step S113).

Upon completion of the IP address dispensing processing, the wireless LAN access point 10A causes the wireless LAN slave device 8 to display the service screen/user authentication screen (step S114).

When the screen transitions to the customer service screen within Ta after the display of the service screen/user authentication screen, the user carrying the wireless LAN slave device 8 can use the customer service such as a coupon (step S115). In addition, in a case where the screen transitions to the user authentication screen within Tb after the display of the service screen/user authentication screen, public wireless LAN connection user authentication is performed for the user carrying the wireless LAN slave device 8 (step S116). Further, the public wireless LAN connection user authentication is also performed for the user who can use the customer service. Upon completion of the user authentication processing, the user can connect to and use the Internet by the wireless LAN slave device 8 (step S117).

A user who actively uses the public wireless LAN service does not remain in the service screen/user authentication screen display. Therefore, if the service screen/user authentication screen remains displayed over the longer time of Ta and Tb, it can be determined that the user does not actively use the service. In this case, in order to prevent the dispensed IP address from being wasted, the wireless LAN access point 10A performs an IP address return processing of collecting the IP address from the wireless LAN slave device 8 (step S118).

Next, a flow B applied to the wireless LAN slave device 8 that cannot expect active use from past connection record information will be described. As illustrated in FIG. 10, the flow B includes step S119 that is not present in the flow A illustrated in FIG. 9. In step S119, the wireless LAN access point 10A executes a “backward alignment guarding process” for minimizing the dispensing of the IP address as much as possible to the wireless LAN slave device 8 that cannot expect active use. In the “backward alignment guarding process”, after the end of the wireless LAN link connection processing, the IP address dispensing processing is not completed unconditionally, but the IP address is dispensed on condition that the wireless LAN link connection processing is repeatedly retried X times.

Since the wireless LAN slave device 8 for which the processing by the flow B is selected is a terminal that cannot expect active use, it is not desired to shift to the IP address dispensing processing as much as possible. However, there is a possibility that the determination result of the active utilization determination based on the past connection record information is different from the actual result. That is, there is a possibility that the wireless LAN slave device 8 is a terminal of a user who desires active use. Since the retry count of X times is provided by the “backward alignment guarding process”, it is possible to dispense the IP address to the wireless LAN slave device 8 of the user who desires active use without dispensing the IP address to the wireless LAN slave device 8 of the user who does not have active use.

### 2-6. Effects of Wireless LAN Access Point According to First Embodiment

As described above, the wireless LAN access point 10A refers to the past connection record information accumulated in itself or the past connection record information aggregated in the wireless LAN controller 4, and performs the active utilization determination of the wireless LAN slave device 8. Then, the connection processing is performed on the basis of the determination result of the active utilization determination. As a result, it is possible to suppress useless IP address dispensing in the public wireless LAN service provided at convenience stores or the like as much as possible, and it is possible to dispense the IP address to the wireless LAN slave device 8 that actually needs the IP address dispensed.

In the connection processing of the wireless LAN slave device 8, it is assumed that the wireless LAN slave device 8 determined to have active utilization does not use the public wireless LAN service as a result, and the wireless LAN access point 10A performs the IP address return processing after a certain time has elapsed from the display of the service screen/user authentication screen. As a result, useless IP addresses can be collected at an early stage. Conversely, the wireless LAN access point 10A performs the backward alignment guarding process as a relief in a case where the wireless LAN slave device 8 determined to have no active utilization is actually a terminal that uses the public wireless LAN service. This makes it possible to avoid a situation in which the wireless LAN slave device 8 that actually wants to use the public wireless LAN service cannot use the public wireless LAN service.

### 3. Wireless LAN Access Point According to Second Embodiment

### (Hot Spot Type)

### 3-1. Configuration of Wireless LAN Access Point

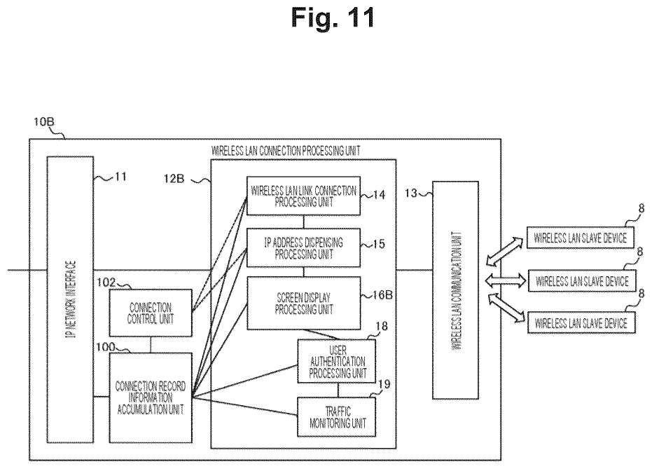

FIG. 11 is a block diagram illustrating a configuration of a hot spot type wireless LAN access point 10B according to the second embodiment. The wireless LAN access point 10B includes an IP network interface 11, a wireless LAN connection processing unit 12B, a wireless LAN communication unit 13, a connection record information accumulation unit 100, and a connection control unit 102. The configuration of the wireless LAN connection processing unit 12B is different from the one of the convenience store type wireless LAN access point 10A according to the first embodiment.

The wireless LAN connection processing unit 12B performs processing when the wireless LAN slave device 8 is connected to the wireless LAN access point 10B. The wireless LAN connection processing unit 12B includes a wireless LAN link connection processing unit 14, an IP address dispensing processing unit 15, a screen display processing unit 16B, a user authentication processing unit 18, and a traffic monitoring unit 19. The hot spot type wireless LAN access point 10B normally does not perform customer service unlike the convenience store type wireless LAN access point 10A. Therefore, unlike the wireless LAN connection processing unit 12A according to the first embodiment, the wireless LAN connection processing unit 12B does not include a customer service use screen display unit, and there is also a difference in the function of the screen display processing unit 16B.

The screen display processing unit 16B displays a user authentication screen necessary for Internet connection by a public wireless LAN service on a web browser mounted on the wireless LAN slave device 8. Since the wireless LAN connection processing unit 12B does not include the customer service use screen display unit, the wireless LAN connection processing unit 12B does not perform the service screen display processing performed by the screen display processing unit 16A according to the first embodiment. In response to the operation for user authentication being performed by the user operation, the screen display processing unit 16B transfers the processing to the user authentication processing unit 18.

The functions of the connection record information accumulation unit 100 and the connection control unit 102 are basically the same as those of the convenience store type wireless LAN access point 10A according to the first embodiment. The connection record information accumulation unit 100 accumulates “connection record information” obtained by processing the “processing log” of the wireless LAN access point 10B when the wireless LAN slave device 8 is connected to the wireless LAN access point 10B. The information accumulated in the connection record information accumulation unit 100 is aggregated in the wireless LAN controller 4. The connection control unit 102 refers to the accumulated connection record information and determines whether or not the wireless LAN slave device 8 connected to the wireless LAN access point 10B is an active public wireless LAN user.

### 3-2. Details of Connection Record Information

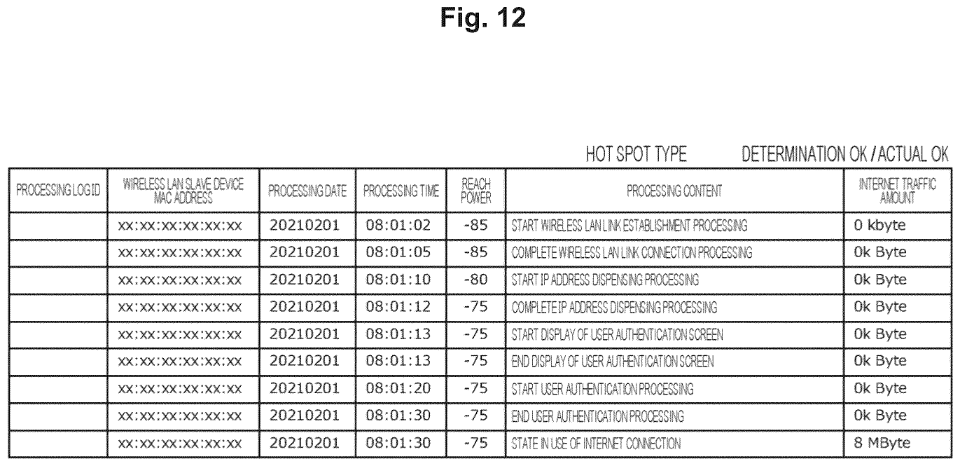

FIG. 12 is a table illustrating an example of a “processing log” in the wireless LAN access point 10B. The “Processing content” recorded is different from the one of the convenience store type wireless LAN access point 10A according to the first embodiment. In the flow in which the wireless LAN slave device 8 is connected to the wireless LAN access point 10B, the “processing content” is one of the following.
Start wireless LAN link connection processing
End wireless LAN link connection processing
Start IP address dispensing processing
End IP address dispensing processing
Start display processing of user authentication screen
End display processing of user authentication screen
Start user authentication processing
End user authentication processing
State in use of internet connection
Start IP address return processing
Complete IP address return processing

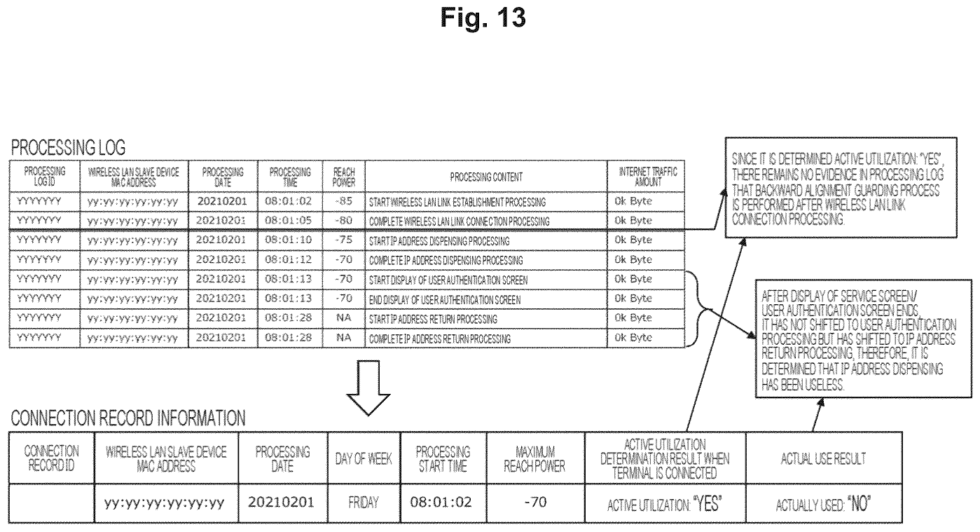

FIG. 13 is a diagram for specifically illustrating an example of conversion from a processing log to connection record information by the wireless LAN access point 10B. In the example illustrated in FIG. 13, the processing log still indicates that the wireless LAN slave device 8 having the MAC address “yy:yy:yy:yy:yy:yy” is connected to the wireless LAN access point 10A on Friday, Feb. 1, 2021, and the processing is started at 8:01:02 AM. The maximum reach power at the time of terminal connection remaining in the processing log is −70 dBm. These pieces of information are directly used as connection record information.

In the example illustrated in FIG. 13, there remains no evidence in the processing log that the backward alignment guarding process is performed after the wireless LAN link connection processing. In a case where the backward alignment guarding process is not performed, the active utilization determination result at the time of terminal connection in the connection record information is “Active utilization: Yes”. In addition, in the processing log, there remains evidence that the display of the user authentication screen has not shifted to the user authentication processing but has shifted to the IP address return processing. Judging from this, it can be determined that the dispensed IP address has been wasted, and the actual use result in the connection record information is “Actually used: No”.

### 3-3. State of Wireless LAN Slave Device

In the present embodiment, in the relationship with the wireless LAN access point 10B, the “state” of the wireless LAN slave device 8 is defined as follows. The content of each state is as described in the first embodiment.
State of “Link unestablished”
State of “Link established”
State of “IP address assigned”
State “in use of Internet connection”

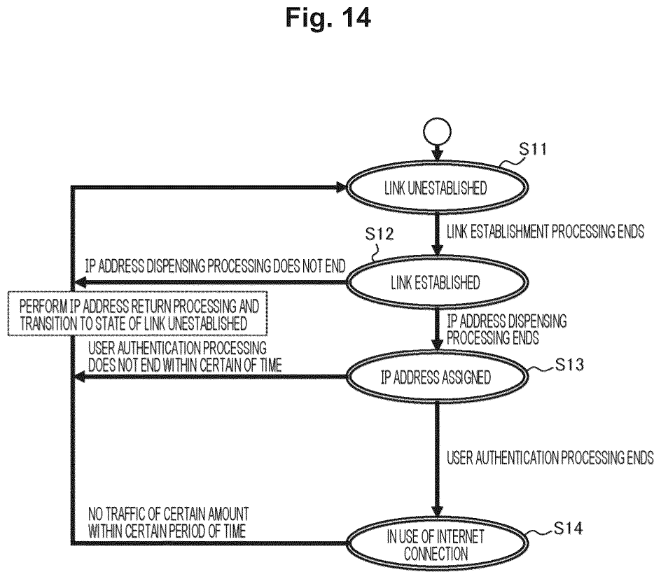

In the present embodiment, the “state” of the wireless LAN slave device 8 transitions as illustrated in FIG. 14 when the wireless LAN slave device 8 is connected to the wireless LAN access point 10B. FIG. 14 is a flowchart illustrating a state transition of a wireless LAN slave device 8 in the relationship with the wireless LAN access point 10B.

The present embodiment is different from the first embodiment in the state transition after the wireless LAN slave device 8 enters the state of “IP address assigned”. In the present embodiment, in a case where the process does not transition to the user authentication processing within a certain period of time after entering the state of “IP address assigned”, the IP address return processing is performed on the wireless LAN slave device 8. As a result, the wireless LAN slave device 8 enters the state of “link unestablished” again (step S11).

When the user authentication processing is completed in the wireless LAN slave device 8 within a certain period of time after entering the state of “IP address assigned”, the wireless LAN slave device 8 enters the state “in use of Internet connection” (step S14). After entering the state “in use of Internet connection”, in a case where there is no traffic of a certain amount within a certain period of time, the IP address return processing is performed on the wireless LAN slave device 8. As a result, the wireless LAN slave device 8 enters the state of “link unestablished” again (step S11).

### 3-4. Description of Active Utilization Determination

The wireless LAN access point 10B determines the possibility of the transition of the wireless LAN slave device 8 to the state “in use of Internet connection” on the basis of the connection record information of the wireless LAN slave device 8 accumulated in itself or the wireless LAN controller 4. Then, to the wireless LAN slave device 8 determined to have a high possibility of transition to the state “in use of Internet connection”, the IP address dispensing processing is performed with the determination of “Active utilization: Yes”. On the other hand, for the wireless LAN slave device 8 that tends not to transition to the state “in use of Internet connection”, the IP address is prevented from being dispensed with the determination of “Active utilization: No”.

The specific example of the active utilization determination of the wireless LAN slave device 8 using the past connection record information described in the first embodiment is also applied to the wireless LAN access point 10B.

### 3-5. Explanation of Communication Resource Allocation Method Based on Determination Result of Active Utilization

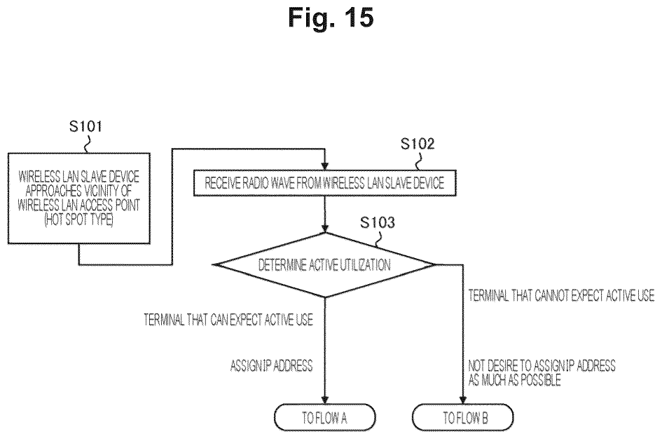

The wireless LAN access point 10B allocates communication resources to the wireless LAN slave device 8, that is, dispenses an IP address, on the basis of the determination result of the active utilization determination. Hereinafter, the processing of dispensing the IP address to the wireless LAN slave device 8 by the wireless LAN access point 10B will be described with reference to FIGS. 15 to 17 illustrating a connection flow of the wireless LAN slave device 8 to the wireless LAN access point 10B. However, the description of processing common to the connection flow executed in the first embodiment will be simplified.

First, as illustrated in FIG. 15, in response to the wireless LAN slave device 8 approaching the vicinity of the wireless LAN access point 10B (step S101), the wireless LAN access point 10B receives a radio wave from the wireless LAN slave device 8 (step S102).

Upon receiving the radio wave from the wireless LAN slave device 8, the wireless LAN access point 10B performs the active utilization determination to determine whether or not the wireless LAN slave device 8 actively uses the public wireless LAN service on the basis of the accumulated connection record information (step S103).

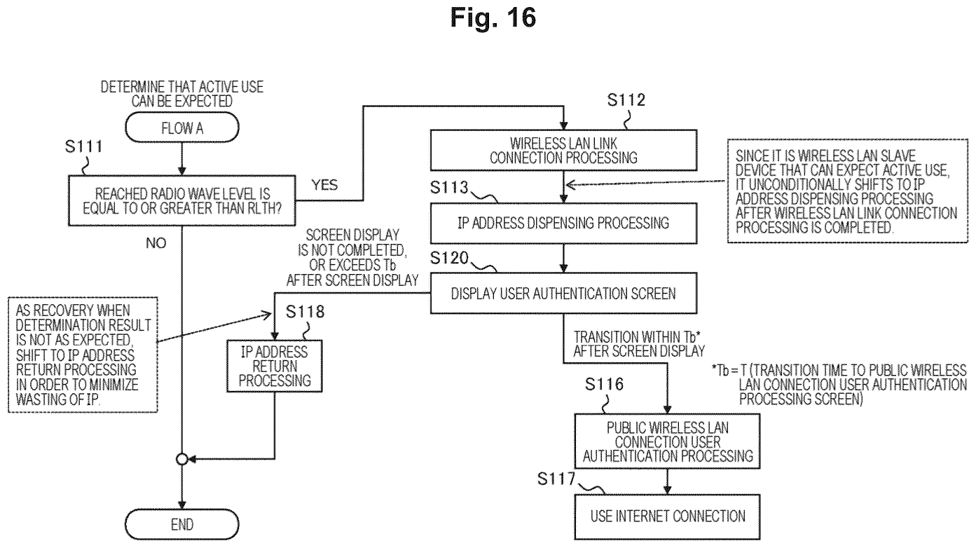

As a result of the active utilization determination, since the IP address may be dispensed to the wireless LAN slave device 8 that can expect active use, the processing of connecting to the wireless LAN access point 10B is performed by applying the flow A illustrated in FIG. 16. The wireless LAN access point 10B first determines whether or not the radio wave reach power from the wireless LAN slave device 8 is equal to or greater than RLTH (step S111). The wireless LAN access point 10B does not perform a wireless LAN link connection processing for the wireless LAN slave device 8 whose radio wave reach power is less than RLTH.

The wireless LAN access point 10B performs a wireless LAN link connection processing for the wireless LAN slave device 8 when the radio wave reach power is equal to or higher than RLTH (step S112), and directly shifts to the IP address dispensing processing when the wireless LAN link connection processing is completed (step S113).

Upon completion of the IP address dispensing processing, the wireless LAN access point 10B causes the wireless LAN slave device 8 to display the user authentication screen (step S120). In addition, in a case where the screen transitions to the user authentication screen within Tb after the display of the user authentication screen, public wireless LAN connection user authentication is performed for the user carrying the wireless LAN slave device 8 (step S116). Upon completion of the user authentication processing, the user can connect to and use the Internet by the wireless LAN slave device 8 (step S117). On the other hand, after Tb has elapsed from the display of the user authentication screen, it can be determined that the user does not actively use the service. Therefore, the wireless LAN access point 10B performs an IP address return processing of collecting the IP address from the wireless LAN slave device 8 (step S118).

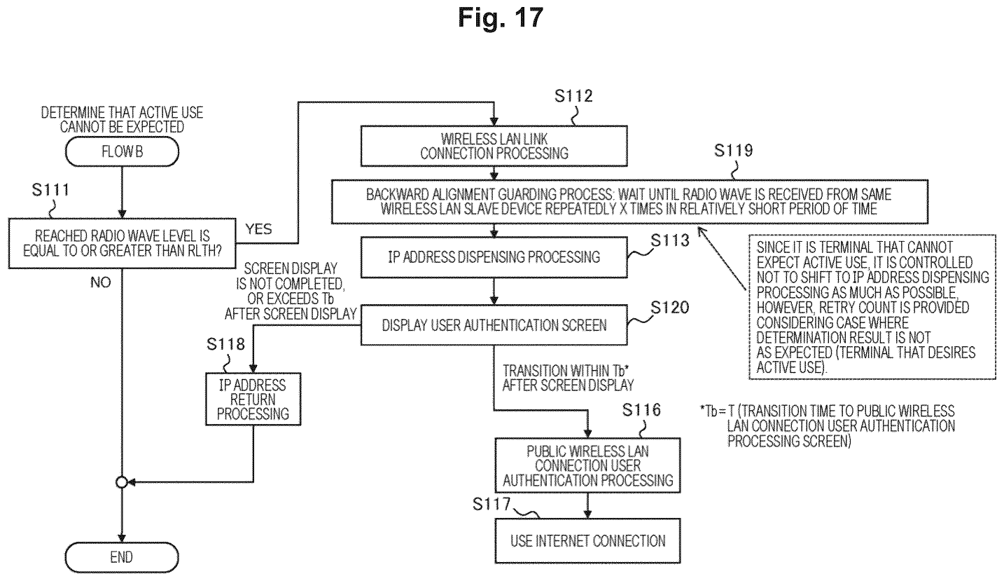

As a result of the active utilization determination, the IP address is not desired to be dispensed to the wireless LAN slave device 8 that is not expected to actively use the public wireless LAN service as much as possible. Therefore, connection processing to the wireless LAN access point 10B is performed by applying the flow B illustrated in FIG. 17. The flow B includes “backward alignment guarding process” in step S119 that is not present in the flow A illustrated in FIG. 16. The contents of the “backward alignment guarding process” are the same as those of the first embodiment. After the wireless LAN link connection processing ends, the “backward alignment guarding process” is executed without unconditionally completing the IP address dispensing processing. As a result, it is possible to dispense the IP address to the wireless LAN slave device 8 of the user who desires to actively use the public wireless LAN service without dispensing the IP address to the wireless LAN slave device 8 of the user who does not have active use of the public wireless LAN service.

### 3-6. Effects of Wireless LAN Access Point According to Second Embodiment

As described above, according to the wireless LAN access point 10B, it is possible to suppress useless IP address dispensing in the hot spot type public wireless LAN service as much as possible. As a result, the IP address can be dispensed to the wireless LAN slave device 8 that actually needs the IP address dispensed.

In addition, in the connection processing of the wireless LAN slave device 8, the wireless LAN access point 10B performs the IP address return processing after a certain time has elapsed from the display of the user authentication screen. As a result, useless IP addresses can be collected at an early stage. Furthermore, the backward alignment guarding process after the end of the wireless LAN link connection processing makes it possible to avoid a situation in which the wireless LAN slave device 8 that actually wants to use the public wireless LAN service cannot use the public wireless LAN service.

### 4. Wireless LAN Access Point According to Third Embodiment

### (Railway Type)

### 4-1. Configuration of Wireless LAN Access Point

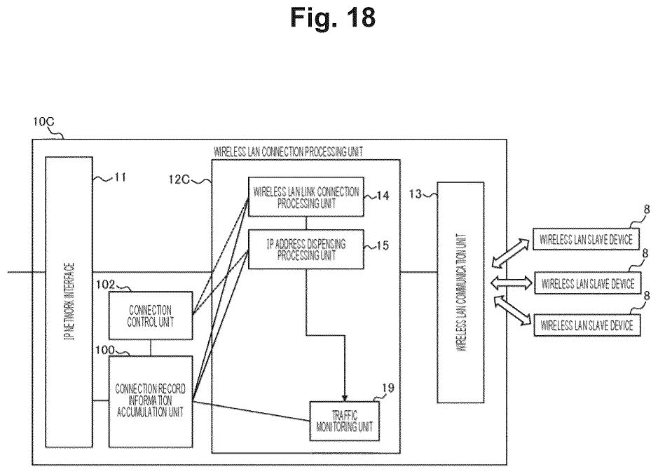

FIG. 18 is a block diagram illustrating a configuration of a railway type wireless LAN access point 10C according to the third embodiment. The wireless LAN access point 10C includes an IP network interface 11, a wireless LAN connection processing unit 12C, a wireless LAN communication unit 13, a connection record information accumulation unit 100, and a connection control unit 102. The configuration of the wireless LAN connection processing unit 12C is different from the one of the convenience store type wireless LAN access point 10A according to the first embodiment and the hot spot type wireless LAN access point 10B according to the second embodiment.

The wireless LAN connection processing unit 12C performs processing when the wireless LAN slave device 8 is connected to the wireless LAN access point 10C. The wireless LAN connection processing unit 12C includes a wireless LAN link connection processing unit 14, an IP address dispensing processing unit 15, and a traffic monitoring unit 19. In the railway type wireless LAN access point 10C, the user authentication processing is not required to use the public wireless LAN service. Therefore, unlike the wireless LAN connection processing unit 12B according to the second embodiment, the wireless LAN connection processing unit 12C does not include a screen display processing unit or a user authentication processing unit.

The functions of the connection record information accumulation unit 100 and the connection control unit 102 are basically the same as those of the convenience store type wireless LAN access point 10A according to the first embodiment. The connection record information accumulation unit 100 accumulates “connection record information” obtained by processing the “processing log” of the wireless LAN access point 10C when the wireless LAN slave device 8 is connected to the wireless LAN access point 10C. The information accumulated in the connection record information accumulation unit 100 is aggregated in the wireless LAN controller 4. The connection control unit 102 refers to the accumulated connection record information and determines whether or not the wireless LAN slave device 8 connected to the wireless LAN access point 10C is an active public wireless LAN user.

### 4-2. Details of Connection Record Information

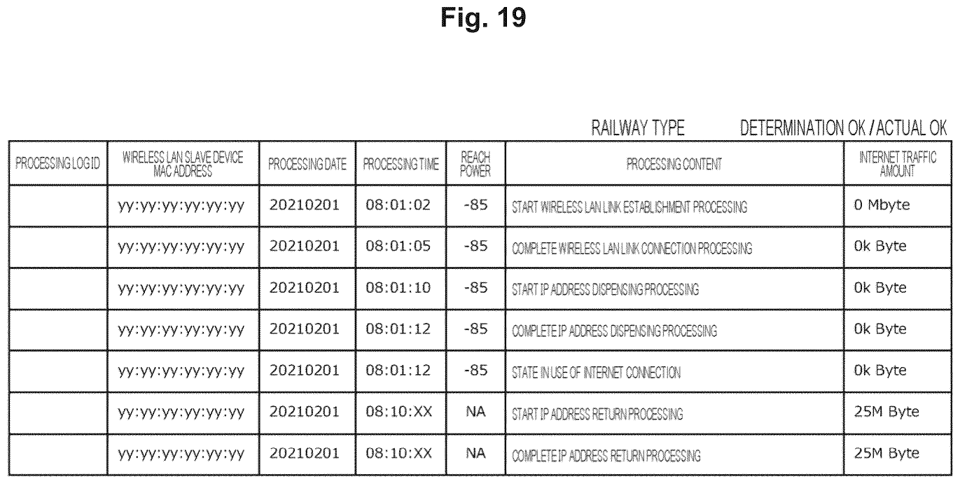

FIG. 19 is a table illustrating an example of a “processing log” in the wireless LAN access point 10C. The “processing content” to be recorded is different from the one of the convenience store type wireless LAN access point 10A according to the first embodiment and the hot spot type wireless LAN access point 10B according to the second embodiment. In the flow in which the wireless LAN slave device 8 is connected to the wireless LAN access point 10C, the “processing content” is one of the following.
Start wireless LAN link connection processing
End wireless LAN link connection processing
Start IP address dispensing processing
End IP address dispensing processing
State in use of internet connection
Start IP address return processing
Complete IP address return processing

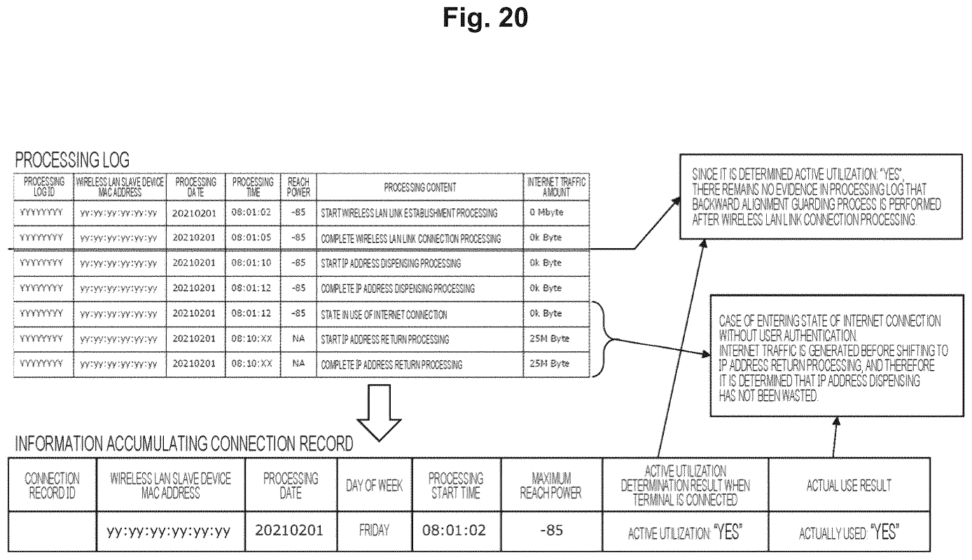

FIG. 20 is a diagram for specifically illustrating an example of conversion from a processing log to connection record information by the wireless LAN access point 10C. In the example illustrated in FIG. 20, the processing log still indicates that the wireless LAN slave device 8 having the MAC address “yy:yy:yy:yy:yy:yy” is connected to the wireless LAN access point 10A on Friday, Feb. 1, 2021, and the processing is started at 8:01:02 AM. The maximum reach power at the time of terminal connection remaining in the processing log is −85 dBm. These pieces of information are directly used as connection record information.

In the example illustrated in FIG. 20, there remains no evidence in the processing log that the backward alignment guarding process is performed after the wireless LAN link connection processing. In a case where the backward alignment guarding process is not performed, the active utilization determination result at the time of terminal connection in the connection record information is “Active utilization: Yes”. In addition, in the processing log, there remains evidence that Internet traffic is generated before shifting to the IP address return processing. Judging from this, it can be determined that the dispensed IP address has not been wasted, and the actual use result in the connection record information is “Actually used: Yes”.

### 4-3. State of Wireless LAN Slave Device

In the present embodiment, in the relationship with the wireless LAN access point 10C, the “state” of the wireless LAN slave device 8 is defined as follows. The contents of each state except for the state of “Internet available” are as described in the first embodiment.
State of “Link unestablished”
State of “Link established”
State of “IP address assigned”
State of “Internet available”
State “in use of Internet connection”

The state of “Internet available” is a state in which Internet connection is available. This is a unique state in relation to the railway type wireless LAN access point 10C. In the railway type, if an IP address is assigned, Internet connection can be unconditionally established. In order to distinguish between presence and absence of active utilization, when a certain amount of traffic is generated within a certain period of time, the state transitions to the state “in use of Internet connection”, and otherwise, the assigned IP address is collected and the state transitions to the state of “link unestablished”.

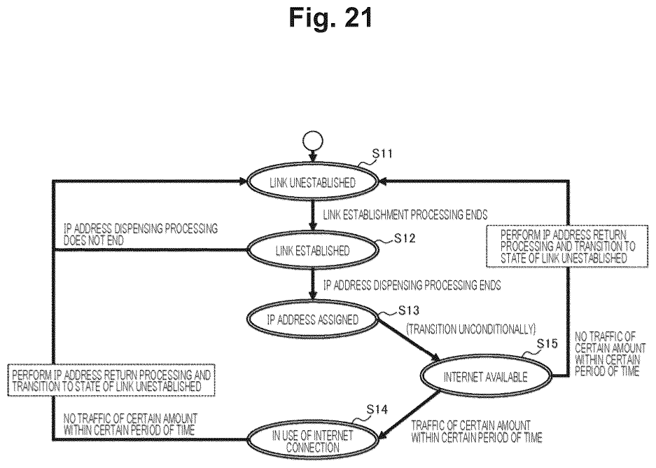

In the present embodiment, the “state” of the wireless LAN slave device 8 transitions as illustrated in FIG. 21 when the wireless LAN slave device 8 is connected to the wireless LAN access point 10C. FIG. 21 is a flowchart illustrating a state transition of a wireless LAN slave device 8 in the relationship with the wireless LAN access point 10C.

The present embodiment is different from the first embodiment and the second embodiment in the state transition after the wireless LAN slave device 8 enters the state of “IP address assigned”. In the present embodiment, after entering the state of “IP address assigned”, the wireless LAN slave device 8 unconditionally transitions to the state of “Internet available” (step S15). Then, when there is traffic of a certain amount within a certain period of time after entering the state of “Internet available”, the wireless LAN slave device 8 enters the state “in use of Internet connection” (step S14).

After entering the state of “Internet available”, in a case where there is no traffic of a certain amount within a certain period of time, the IP address return processing is performed on the wireless LAN slave device 8. As a result, the wireless LAN slave device 8 enters the state of “link unestablished” again (step S11). In addition, after entering the state “in use of Internet connection”, also in a case where there is no traffic of a certain amount within a certain period of time, the IP address return processing is performed on the wireless LAN slave device 8. As a result, the wireless LAN slave device 8 enters the state of “link unestablished” again (step S11).

### 4-4. Description of Active Utilization Determination

The wireless LAN access point 10C determines the possibility of the transition of the wireless LAN slave device 8 to the state “in use of Internet connection” on the basis of the connection record information of the wireless LAN slave device 8 accumulated in itself or the wireless LAN controller 4. Then, to the wireless LAN slave device 8 determined to have a high possibility of transition to the state “in use of Internet connection”, the IP address dispensing processing is performed with the determination of “Active utilization: Yes”. On the other hand, for the wireless LAN slave device 8 that tends not to transition to the state “in use of Internet connection”, the IP address is prevented from being dispensed with the determination of “Active utilization: No”.

The specific example of the active utilization determination of the wireless LAN slave device 8 using the past connection record information described in the first embodiment is also applied to the wireless LAN access point 10C.

Note that, in the wireless LAN access point 10C, all the wireless LAN slave devices 8 transition to the state “in use of Internet connection” in the last stage regardless of whether or not the user wants to actively use the public wireless LAN service. Therefore, the presence or absence of active utilization can be distinguished by how much traffic has actually flowed after transitioning to the state “in use of Internet connection”. By accumulating the information of the traffic amount and the MAC address of the wireless LAN slave device 8 in association with the reach power to the wireless LAN access point 10C, it is possible to grasp the tendency of the active use for each MAC address.

### 4-5. Explanation of Communication Resource Allocation Method Based on Determination Result of Active Utilization

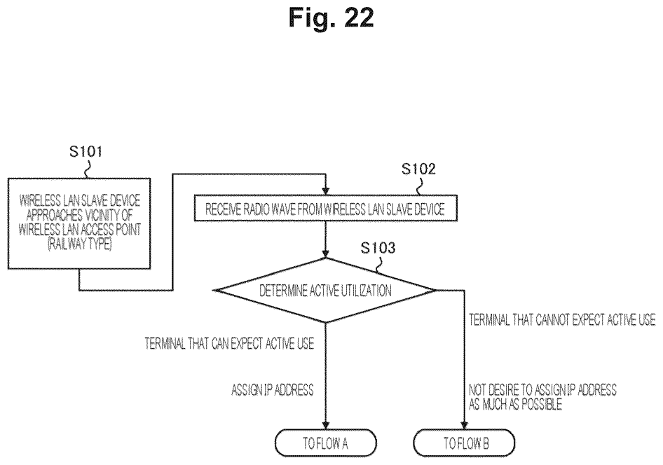

The wireless LAN access point 10C allocates communication resources to the wireless LAN slave device 8, that is, dispenses an IP address, on the basis of the determination result of the active utilization determination. Hereinafter, the processing of dispensing the IP address to the wireless LAN slave device 8 by the wireless LAN access point 10C will be described with reference to FIGS. 22 to 24 illustrating a connection flow of the wireless LAN slave device 8 to the wireless LAN access point 10C. However, the description of processing common to the connection flow executed in the first embodiment or the second embodiment will be simplified.

First, as illustrated in FIG. 22, in response to the wireless LAN slave device 8 approaching the vicinity of the wireless LAN access point 10C (step S101), the wireless LAN access point 10C receives a radio wave from the wireless LAN slave device 8 (step S102).

Upon receiving the radio wave from the wireless LAN slave device 8, the wireless LAN access point 10C performs the active utilization determination to determine whether or not the wireless LAN slave device 8 actively uses the public wireless LAN service on the basis of the accumulated connection record information (step S103).

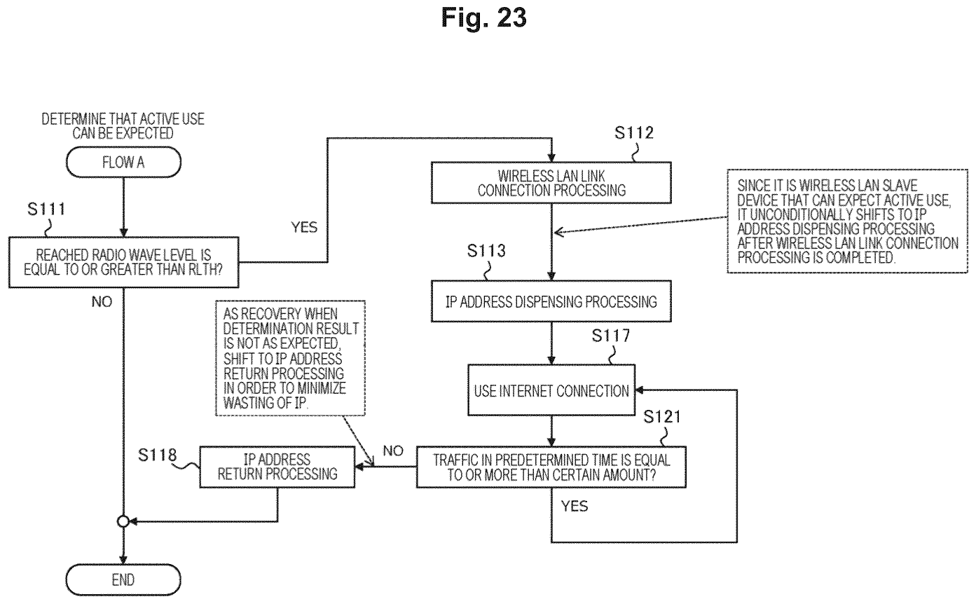

As a result of the active utilization determination, since the IP address may be dispensed to the wireless LAN slave device 8 that can expect active use of the public wireless LAN service, the processing of connecting to the wireless LAN access point 10C is performed by applying the flow A illustrated in FIG. 23. The wireless LAN access point 10C first determines whether or not the radio wave reach power from the wireless LAN slave device 8 is equal to or greater than RLTH (step S111). The wireless LAN access point 10C does not perform a wireless LAN link connection processing for the wireless LAN slave device 8 whose radio wave reach power is less than RLTH.

The wireless LAN access point 10C performs a wireless LAN link connection processing for the wireless LAN slave device 8 when the radio wave reach power is equal to or higher than RLTH (step S112), and directly shifts to the IP address dispensing processing when the wireless LAN link connection processing is completed (step S113). Upon completion of the IP address dispensing processing, the user can connect to and use the Internet by the wireless LAN slave device 8 (step S117).

While the use of Internet connection by the wireless LAN slave device 8 is enabled, the wireless LAN access point 10C determines whether traffic in a predetermined time is equal to or more than a certain amount (step S121). While the traffic of equal to or more than a certain amount is maintained, the state in which internet connection by the wireless LAN slave device 8 can be used is maintained (step S117). On the other hand, when the traffic in a predetermined time is less than a certain amount, it can be determined that the user does not have active use. Therefore, the wireless LAN access point 10C performs an IP address return processing of collecting the IP address from the wireless LAN slave device 8 (step S118).

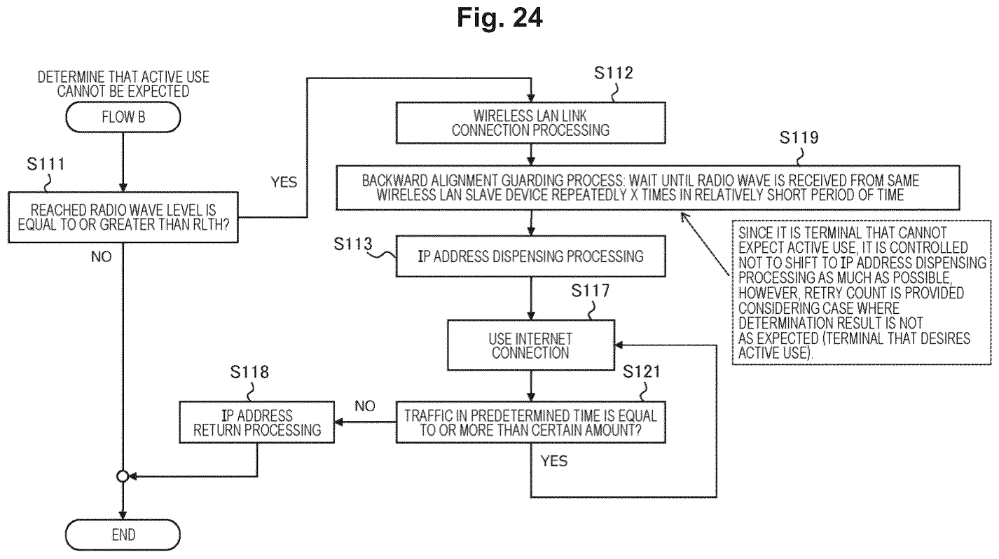

As a result of the active utilization determination, the IP address is not desired to be dispensed to the wireless LAN slave device 8 that is not expected to actively use the public wireless LAN service as much as possible. Therefore, connection processing to the wireless LAN access point 10C is performed by applying the flow B illustrated in FIG. 24. The flow B includes “backward alignment guarding process” in step S119 that is not present in the flow A illustrated in FIG. 23. The contents of the “backward alignment guarding process” are the same as those of the first embodiment and the second embodiment. After the wireless LAN link connection processing ends, the “backward alignment guarding process” is executed without unconditionally completing the IP address dispensing processing. As a result, it is possible to dispense the IP address to the wireless LAN slave device 8 of the user who desires to actively use the public wireless LAN service without dispensing the IP address to the wireless LAN slave device 8 of the user who does not have active use of the public wireless LAN service.

### 4-6. Effects of Wireless LAN Access Point According to Third Embodiment

As described above, according to the wireless LAN access point 10C, it is possible to suppress useless IP address dispensing in the railway type public wireless LAN service as much as possible. As a result, the IP address can be dispensed to the wireless LAN slave device 8 that actually needs the IP address dispensed.

In addition, in the connection processing of the wireless LAN slave device 8, the wireless LAN access point 10C performs the IP address return processing when the traffic amount in a predetermined time at the time of using Internet connection is less than a certain amount. As a result, useless IP addresses can be collected at an early stage. Furthermore, the backward alignment guarding process after the end of the wireless LAN link connection processing makes it possible to avoid a situation in which the wireless LAN slave device 8 that actually wants to use the public wireless LAN service cannot use the public wireless LAN service.

### 5. Example of Hardware Configuration of Wireless LAN Access Point Common to Each Embodiment

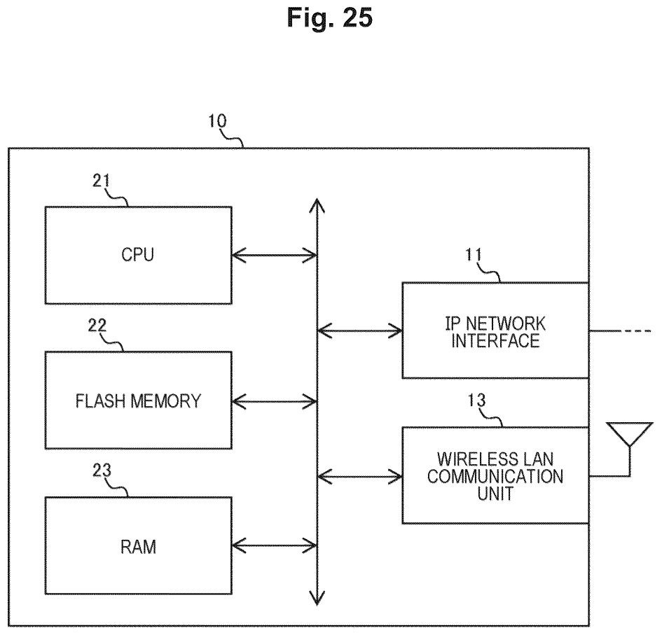

A hardware configuration of the wireless LAN access point 10 common to each embodiment of the present disclosure will be described with reference to FIG. 25. FIG. 25 is a block diagram illustrating an example of a hardware configuration of the wireless LAN access point 10 common to each embodiment of the present disclosure.

The functions of the wireless LAN access points 10A, 10B, and 10C illustrated in FIGS. 2, 11, and 18 are implemented by the CPU 21, the flash memory 22, and the RAM 23 as illustrated in FIG. 25. The flash memory 22 stores one or a plurality of programs that can be executed by the CPU 21 and various types of information related thereto. The CPU 21 executes the program to implement the functions of the wireless LAN access points 10A, 10B, and 10C, specifically, the wireless LAN connection processing units 12A, 12B, and 12C, the connection record information accumulation unit 100, and the connection control unit 102. Note that the program can be stored in a computer-readable recording medium that is an auxiliary storage device, or can be provided through a network.

### 6. Others

The embodiments described above can be variously modified and implemented without departing from the gist of the present disclosure. That is, when a number such as the number of each element, numerical quantity, an amount, a range, or the like is mentioned in the above embodiment, the technique according to the present disclosure is not limited to the mentioned number unless otherwise specified or clearly specified in principle. In addition, the structures and the like described in the above embodiments are not necessarily essential to the technique according to the present disclosure unless otherwise specified or clearly specified in principle.

Furthermore, the wireless communication system of the present disclosure is not limited to the public wireless LAN system as in the above-described embodiment, and can be applied to various wireless communication systems including an intra-company wireless LAN system, a system that connects a mobile phone base station and a terminal in 4G and 5G mobile phone services, and a satellite IoT system.

### REFERENCE SIGNS LIST

2 Public wireless LAN system
4 Wireless LAN controller
5 IP network
8 Wireless LAN slave device
10, 10A, 10B, 10C Wireless LAN access point
11 IP network interface
12A, 128, 12C Wireless LAN connection processing unit
13 Wireless LAN communication unit
100 Connection record information accumulation unit
102 Connection control unit

1. A wireless base station comprising circuitry configured to execute:
determining active utilization of a wireless communication service by a wireless terminal on the basis of past connection record information of the wireless terminal in response to reception of a radio wave from the wireless terminal;
allocating a communication resource to the wireless terminal under a condition of a predetermined connection operation by the wireless terminal when the wireless terminal is a terminal that cannot expect active use of the wireless communication service; and
allocating the communication resource to the wireless terminal without setting the predetermined connection operation as a condition when the wireless terminal is a terminal that can expect active use of the wireless communication service.

2. The wireless base station according to claim 1, wherein the circuitry is further configured to further execute:
causing the wireless terminal to return the communication resource when a usage record of the wireless communication service by the wireless terminal is less than a reference record after allocating the communication resource to the wireless terminal.

3. The wireless base station device according to claim 1, wherein the circuitry is further configured to further execute:
causing the wireless terminal to return the communication resource when the wireless communication service is not used within a predetermined time after allocating the communication resource to the wireless terminal.

4. The wireless base station according to claim 1, wherein the circuitry is further configured to further execute:
performing a connection processing between the wireless terminal and the wireless base station on condition that a level of the radio wave is a predetermined threshold or more.

5. The wireless base station according to claim 1, wherein the circuitry is further configured to further execute:
generating the connection record information from a processing log when the wireless terminal is connected to the wireless base station; and
accumulating the generated connection record information in the wireless base station itself or accumulating the generated connection record information in control circuitry that manages a plurality of wireless base station including the wireless base station.

6. The wireless base station according to claim 1, wherein;
the wireless communication service is a public wireless local area network (LAN) service, and
the communication resource is an internet protocol (IP) address.

7. A wireless communication system in which a wireless base station and control circuitry that manages the wireless base station are connected via a communication network,
the wireless communication system including circuitry configured to execute:
determining active utilization of a wireless communication service by a wireless terminal on the basis of past connection record information of the wireless terminal accumulated in the wireless base station or the control circuitry in response to reception of a radio wave from the wireless terminal by the wireless base station;
allocating a communication resource from the wireless base station to the wireless terminal under a condition of a predetermined connection operation by the wireless terminal when the wireless terminal is a terminal that cannot expect active use of the wireless communication service; and
allocating the communication resource from the wireless base station to the wireless terminal without setting the predetermined connection operation as a condition when the wireless terminal is a terminal that can expect active use of the wireless communication service.

8. A wireless communication method, comprising:
determining active utilization of a wireless communication service by a wireless terminal on the basis of past connection record information of the wireless terminal in response to reception of a radio wave from the wireless terminal;
allocating a communication resource to the wireless terminal under a condition of a predetermined connection operation by the wireless terminal when the wireless terminal is a terminal that cannot expect active use of the wireless communication service; and
allocating the communication resource to the wireless terminal without setting the predetermined connection operation as a condition when the wireless terminal is a terminal that can expect active use of the wireless communication service.

9. A non-transitory computer readable medium storing instructions which when executed by a base station cause the base station to perform the method of claim 8.
